(19) United States
(12) Patent Application Publication
(10) Pub. No.: US 2018/0375881 A1
(43) Pub. Date: Dec. 27, 2018

(54) INFORMATION PROCESSING DEVICE, INFORMATION PROCESSING METHOD, AND NON-TRANSITORY COMPUTER READABLE RECORDING MEDIUM

(71) Applicant: Panasonic Intellectual Property Management Co., Ltd., Osaka (JP)

(72) Inventors: HIROYUKI WADA, Kyoto (JP); TOHRU WAKABAYASHI, Hyogo (JP); TOSHIHISA NAKANO, Osaka (JP); KEIICHI HIGO, Kyoto (JP)

(21) Appl. No.: 16/007,039

(22) Filed: Jun. 13, 2018

(30) Foreign Application Priority Data
Jun. 26, 2017 (JP) 2017-124658

(51) Int. Cl. H04L 29/06

(52) U.S. Cl. CPC H04L 63/1416; H04W 12/12

(57) ABSTRACT

An information processing device is connected to a network where a plurality of electronic control units perform communication. The information processing device includes a receiver that receives a frame containing data over the network, an acquisition unit that acquires sensor information obtained by sensing of a first sensor, and a determination unit that determines whether the data is illegal based on the sensor information.

The present application claims the benefit of foreign priority of Japanese patent application 2017-124658 filed on Jun. 26, 2017, the contents all of which are incorporated herein by reference.

### BACKGROUND

### 1. Technical Field

The present disclosure relates to a security technology for handling an illegal frame transmitted over a network where a plurality of electronic control units perform communication.

### 2. Description of the Related Art

Recently, a motor vehicle includes a number of electronic control units (ECUs), and such electronic control units constitute a communication network, which is referred to as an in-vehicle network, for controlling the motor vehicle. The ECUs perform communication over a bus (network bus), which is a transmission path, in accordance with, for example, the controller area network (CAN) standard specified in ISO 11898.

An ECU serving as a transmitting node transmits a data frame containing an identifier (ID), and each ECU serving as a receiving node receives a data frame containing an ID associated beforehand with the ECU. A number of ECUs each transmit and receive various types of data frames. For example, the ECUs cooperate with each other by transmitting and receiving the data frames to achieve various types of functions of an advanced driver assistance system (ADAS). The ADAS uses information based on a result of sensing (for example, measurement and detection) of a sensor mounted on a motor vehicle to recognize, for example, a state of the motor vehicle and a surrounding environment of the motor vehicle and control the motor vehicle, which achieves, for example, a parking assistance function, a lane keeping assistance function, and a collision avoidance assistance function.

Now, there is a threat of the motor vehicle being illegally controlled by an attacker through transmitting an attack frame over the bus by, for example, connecting an ECU that is an illegal node to a bus of an in-vehicle network or attacking an ECU or the like capable of communicating with a device such as a handheld information terminal or a communication device located outside a motor vehicle to convert the ECU into an illegal node. Such an attack frame transmitted by the illegal attacker is an abnormal frame that cannot be transmitted over the in-vehicle network in a normal state and can contain information falsified to indicate a false state of the motor vehicle, for example. For example, the use of such an attack frame that is falsified to indicate that a vehicle speed is zero when the vehicle is traveling, may cause an accident such as a collision with an obstacle.

For detecting and handling such an attack frame, that is, an abnormal frame, there is a technology for determining that the frame is an abnormal frame, when numerical information, such as a wheel speed, as data related to a frame received over the in-vehicle network, is greater than a specific value predetermined as a reference value (refer to Unexamined Japanese Patent Publication No. 2008-114806).

### SUMMARY

The present disclosure provides an information processing device, an information processing method, and a non-transitory computer readable recording medium that are capable of handling an attack frame transmitted by an attacker over a network where a plurality of electronic control units perform communication.

An information processing device according to one aspect of the present disclosure is connected to a network where a plurality of electronic control units perform communication. The information processing device includes a receiver that receives a frame containing data over the network, an acquisition unit that acquires sensor information obtained by sensing of a first sensor, and a determination unit that determines whether the data is illegal based on the sensor information.

Furthermore, an information processing method according to one aspect of the present disclosure is used in an information processing device connected to a network where a plurality of electronic control units perform communication. The information processing method includes receiving a frame containing data over the network, acquiring sensor information obtained by sensing of a first sensor connected with the information processing device, and determining whether the data is illegal based on the sensor information.

Furthermore, a non-transitory computer readable recording medium according to one aspect of the present disclosure contains a program that causes an information processing device to execute a specific information process, the information processing device including a microprocessor and being connected to a network where a plurality of electronic control units perform communication. The specific information process includes receiving a frame containing data over the network, acquiring sensor information obtained by sensing of a first sensor, and determining whether the data is illegal based on the sensor information.

The present disclosure makes it possible to handle an attack frame transmitted by an attacker.

### BRIEF DESCRIPTION OF THE DRAWINGS

FIG. 1 is a diagram illustrating an overall configuration of an in-vehicle network system according to a first exemplary embodiment;

FIG. 2 is a diagram illustrating a format of a data frame specified in the CAN protocol;

FIG. 3 is a diagram illustrating a format of an error frame specified in the CAN protocol;

FIG. 4 is a diagram illustrating examples of frames to be transmitted and received between ECUs related to an emergency braking function according to the first exemplary embodiment;

FIG. 5 is a block diagram of a brake ECU according to the first exemplary embodiment;

FIG. 6 is a diagram illustrating an example of information for illegal frame determination used by the brake ECU according to the first exemplary embodiment;

FIG. 7 is a flowchart illustrating an example of an illegal frame determination process performed by the brake ECU according to the first exemplary embodiment;

FIG. 8 is a diagram illustrating an example of a process sequence among a plurality of ECUs that cooperate with each other for the emergency braking function according to the first exemplary embodiment;

FIG. 9 is a flowchart illustrating an example of an illegal frame determination process according to a modification of the first exemplary embodiment;

FIG. 10 is a diagram illustrating an example of a process sequence among a plurality of ECUs that cooperate with each other for an emergency braking function according to the modification of the first exemplary embodiment;

FIG. 11 is a diagram illustrating an overall configuration of an in-vehicle network system according to a second exemplary embodiment;

FIG. 12 is a diagram illustrating examples of frames to be transmitted and received between ECUs related to an emergency braking function according to the second exemplary embodiment;

FIG. 13 is a block diagram of a camera ECU according to the second exemplary embodiment;

FIG. 14 is a diagram illustrating an example of information for illegal frame determination used by the camera ECU according to the second exemplary embodiment;

FIG. 15 is a flowchart illustrating an example of an illegal frame determination process performed by the camera ECU according to the second exemplary embodiment; and

FIG. 16 is a diagram illustrating an example of a process sequence among a plurality of ECUs that cooperate with each other for the emergency braking function according to the second exemplary embodiment.

### DETAILED DESCRIPTION

Prior to describing exemplary embodiments of the present disclosure, problems found in a conventional technique will be now briefly described herein. The technique disclosed in Unexamined Japanese Patent Publication No. 2008-114806 has a problem in that the technique is effective only on a frame containing data on which a determination can be made based on a predetermined specific value.

### (Knowledge Underlying the Present Disclosure)

A vehicle such as a motor vehicle and a production facility in a factory includes a plurality of sensors, actuators, and the like. In order to achieve various control functions, various types of ECUs connected to the sensors, actuators, and the like perform communication over a network in accordance with the CAN protocol. For example, for an emergency braking function that is one of collision avoidance assist functions of the ADAS of a vehicle, an engine ECU, a sensor ECU, a brake ECU cooperate with each other. For example, the engine ECU controls an engine and transmits a frame indicating a vehicle speed. The sensor ECU, for example, detects an obstacle on a road in a travelling direction of the vehicle based on a result of sensing of a sensor and transmits, based on the vehicle speed, a frame or the like indicating a brake instruction for emergency braking in order to avoid collision with the obstacle. Furthermore, the brake ECU controls brakes, that is, a braking device, in accordance with the brake instruction.

With the emergency braking function of the ADAS, for example, in a case where a travelling vehicle approaches an obstacle ahead of the vehicle and cannot avoid the obstacle by, for example, steering control of the vehicle due to a distance and a vehicle speed with respect to the obstacle, the sensor ECU transmits a frame indicating the brake instruction, and then brake ECU performs braking control to stop the vehicle, thereby avoiding collision with the obstacle.

However, when an attacker transmits, over an in-vehicle network, an attack frame that is an illegal frame falsified to, for example, indicate a false state of the vehicle, the emergency braking function is not appropriately performed, which may cause a vehicular accident or the like. For example, when a travelling vehicle approaches an obstacle ahead of the vehicle, transmission of an attack frame falsified to indicate that the vehicle speed is 0 km/h causes the sensor ECU to erroneously recognize that the vehicle is at a stop, which prevents the sensor ECU from transmitting a frame indicating the brake instruction.

Therefore, in an information processing method according to the present disclosure, in order to enhance security of an in-vehicle network for handling such an attack frame, determination is made whether a frame on the in-vehicle network (for example, a frame indicating a vehicle speed) is illegal based on a result of sensing of a sensor.

An information processing device according to one aspect of the present disclosure determines whether a frame is illegal in accordance with the information processing method. This determination makes it possible to prevent a frame determined to be illegal from exerting an adverse effect. The information processing device that is connected to the in-vehicle network and mounted on the vehicle acquires sensor information corresponding to a result of sensing of an in-vehicle sensor and determines whether a frame is illegal based on the sensor information. The above-described vehicle speed corresponding to content of the attack frame falsified to indicate that the vehicle speed is 0 km/h is in disagreement with a wheel speed or the like indicated by the sensor information acquired by the information processing device and corresponding to, for example, a result of sensing of a wheel speed sensor, which allows the information processing device to determine that the attack frame is illegal. This determination result makes it possible to prevent a vehicular accident or the like. Note that such information processing device and information processing method are applicable to a production facility, a robot, and the like in a factory in addition to a vehicle.

The information processing device according to the one aspect of the present disclosure is connected to a network where a plurality of electronic control units perform communication. The information processing device includes a receiver that receives a frame containing data over the network, an acquisition unit that acquires sensor information obtained by sensing of a first sensor, and a determination unit that determines whether the data is illegal based on the sensor information. This configuration allows determination whether a frame is illegal to be made even on a frame that cannot be determined whether the frame is illegal based on a specific value. This determination makes it possible to appropriately handle the attack frame transmitted by the attacker (for example, overriding an illegal frame).

Note that, the first sensor may be a sensor included in the information processing device or an external sensor. Furthermore, the first sensor may be a single sensor or a sensor system including a plurality of sensors that are connected with each other.

The determination made by the determination unit may be made such that, for example, a result of the determination is stored in a register, a memory, a hard disk, or other recording media. For example, the determination corresponds to agreement determination between the content of the frame and the sensor information, that is, determination whether the content of the frame and the sensor information satisfy a predetermined relationship. For example, a specific operation is predetermined in consideration of a predetermined relationship such that a result of the specific operation performed on value X indicated by a specific data of the content of the frame and value A indicated by the sensor information corresponding to a result of sensing of the first sensor can be determined whether the result is illegal, which allows the determination unit to make determination with the specific operation.

Value X may correspond to a value of the specific data itself or may correspond to a value derived from the value of the specific data with, for example, a predetermined operation. Similarly, value A may correspond to a value of the sensor information itself or may correspond to a value derived from the value of the sensor information with, for example, a predetermined operation. Furthermore, value X and value A are not limited to numerical values and may be logical values in the form of, for example, a flag, and the above-described specific operation is not limited to an arithmetic operation and may be a logical operation. As an example, the determination unit may determine that the frame is illegal in a case where value A and value X are in disagreement with each other. Otherwise, the determination unit may determine that the frame is not illegal. Furthermore, as another example, the determination unit may determine that the frame is illegal in a case where value X is less than A−M1 or more than A+M2, where M1 is a lower margin of value A and M2 is an upper margin of value A. Otherwise, the determination unit may determine that the frame is not illegal.

Furthermore, for example, the sensor information may indicate a first-type physical quantity obtained by sensing of the first sensor. A first electronic control unit of the plurality of electronic control units may successively transmit a first-type frame containing data indicating a second-type physical quantity that has a positive or negative correlation with the first-type physical quantity in a normal state. That is, the plurality of electronic control units may include the first electronic control unit, and the frame may include the first-type frame that is transmitted by the first electronic control unit. Furthermore, the first-type frame may contain, as the data, data indicating the second-type physical quantity that has a positive or negative correlation with the first-type physical quantity in the normal state. The determination unit may determine whether the data contained in the first-type frame is illegal based on the sensor information. The normal state corresponds to a period of operation in compliance with specifications, which is different from an abnormal state where control by the attacker or failure occurs. This configuration allows the determination whether the data contained in the first-type frame is illegal to be appropriately made based on whether, for example, the data and the first-type physical quantity indicated by the sensor information have a certain relationship. Accordingly, in a case where the attacker transmits, over a network, a first-type frame containing falsified data, appropriate handling is possible.

Furthermore, for example, the determination unit may determine that the first-type frame is illegal in a case where a value indicated by the data contained in the first-type frame is out of a range from a lower limit value to an upper limit value specified based on the sensor information. This configuration makes it possible to determine that a frame is illegal in a case where the value of the data of the frame is out of a range defined from, for example, the first-type physical quantity indicated by the sensor information in consideration of existence of a certain error. This makes it possible to prevent the first electronic control unit from erroneously determining that an appropriate first-type frame transmitted by a normal first electronic control unit is illegal due to differences in, for example, sensing condition, method, and accuracy between a sensor from which the first-type frame is generated and the first sensor.

Furthermore, for example, the first-type physical quantity and the second-type physical quantity may be vehicle speeds. This configuration allows the determination unit to determine whether the vehicle speed data contained in the first-type frame is illegal based on the sensor information indicating a vehicle speed.

Furthermore, for example, the first electronic control unit of the plurality of electronic control units may successively transmit the first-type frame containing data generated based on a result of sensing of a second sensor in the normal state, the second sensor being different from the first sensor and being configured to perform sensing on all or part of a target range of the sensing of the first sensor. That is, the plurality of electronic control units may include the first electronic control unit, and the frame may include at least one first-type frame that is transmitted by the first electronic control unit. Furthermore, the first-type frame contains, as the data, data generated based on a result of sensing of the second sensor in the normal state, the second sensor being different from the first sensor and being configured to perform sensing on all or part of the target range of the sensing of the first sensor. The determination unit may determine whether the data contained in the first-type frame is illegal based on the sensor information. This configuration allows the determination whether the data contained in the first-type frame is illegal to be appropriately made based on, for example, information on an overlapping portion between respective ranges of the sensing of the first sensor and the sensing of the second sensor.

Furthermore, for example, the determination unit may determine whether the data contained in the first-type frame is illegal based on the sensor information and information determined based on respective target ranges of the sensing of the first sensor and the sensing of the second sensor. This configuration allows a determination to be appropriately made based on, for example, a difference between sensing conditions of the sensors. Note that, the information determined based on the target range of sensing corresponds to information, such as a reference position, size, or resolution of the sensing range, which is used to make the data and the sensor information comparable. For example, this information is used for conversion of a value related to the data or the sensor information for a specific operation for the determination made by the determination unit.

Furthermore, for example, the first electronic control unit of the plurality of electronic control units may successively transmit the first-type frame containing data generated based on a result of the sensing of the first sensor in the normal state. That is, the plurality of electronic control units may include the first electronic control unit, and the frame may include at least one first-type frame that is transmitted by the first electronic control unit. Furthermore, the first-type frame may contain, as the data, data generated based on a result of the sensing of the first sensor in the normal state. The determination unit may determine whether the data contained in the first-type frame is illegal based on the sensor information. This configuration allows determination to be appropriately made because the data of the frame transmitted by the first electronic control unit is determined based on the sensor information that is obtained from the first sensor and on the basis of which the data is generated, and respective sensors, as sources, of the data and the sensor information are identical to each other in the normal state.

Furthermore, for example, the information processing device, the plurality of electronic control units, and the first sensor may be mounted on a vehicle, and the network may be an in-vehicle network. Furthermore, the first-type frame may contain, as the data, data indicating a state of the vehicle. This configuration allows detection of an attack frame containing data falsified to indicate a false state of the vehicle.

Furthermore, for example, the first-type frame may contain data indicating the state of the vehicle that is used for condition determination whether specific control on the vehicle is possible. The determination unit may determine whether the data contained in the latest first-type frame is illegal based on the sensor information when a second-type frame indicating the specific control is received by the receiver. That is, the first-type frame includes the latest first-type frame, and the latest first-type frame may contain, as the data, data indicating the state of the vehicle that is used for condition determination whether the specific control on the vehicle is possible. Furthermore, the determination unit may determine whether the data contained in the latest first-type frame is illegal based on the sensor information when the second-type frame indicating the specific control is received by the receiver. This configuration allows determination to be made more efficiently because the determination is made when the specific control is performed based on the state of the vehicle.

Furthermore, for example, information processing device may further include a processor that performs a specific process in a case where the determination unit determines that the data contained in the first-type frame is illegal and does not perform the specific process in a case where the determination unit determines that the data contained in the first-type frame is not illegal. This configuration allows handling of an illegal frame. The specific process includes, for example, prevention of transmission of the illegal frame, and notification of abnormality.

Furthermore, for example, the specific process may correspond to a process for preventing the first-type frame from being transmitted. This configuration makes it possible to prevent an adverse effect caused by transmission of the illegal frame. The prevention of transmission of the illegal frame includes, for example, overriding the illegal frame by altering the illegal frame on the network, and preventing the illegal frame being transferred in a case where the information processing device is capable of transferring a frame over the network.

Furthermore, for example, the plurality of electronic control units may perform communication over a bus in accordance with the controller area network (CAN) protocol, and the determination unit may determine whether the content of the first-type frame is illegal before the receiver receives the last bit of the first-type frame. The information processing device may further include a processor that transmits an error frame over the bus before the receiver receives the last bit of the first-type frame in a case where the determination unit determines that the content of the first-type frame is illegal. Accordingly, the transmission of the error frame makes it possible to prevent the illegal frame from being transmitted, which in turn makes it possible to prevent an adverse effect caused by the transmission of the illegal frame.

Furthermore, for example, the sensor information may include latest sensor information already acquired and sensor information whose term of validity has not expired. Furthermore, the acquisition unit may acquire new sensor information whose term of validity has not expired in a case where the term of validity of the latest sensor information already acquired has expired. The determination unit may determine whether the data contained in the first-type frame is illegal based on the sensor information whose term of validity has not expired. This configuration makes it possible to prevent erroneous determination due to that a difference between a reception timing of the frame and an acquisition timing of the sensor information is out of a certain range.

Furthermore, for example, the determination unit may determine whether the data contained in a predetermined specific position in the first-type frame is illegal based on the sensor information. This configuration allows determination to be made whether data contained in a specific position, such as data in the data field, in data frame in accordance with CAN.

Furthermore, for example, a second electronic control unit, which is different from the first electronic control unit, of the plurality of electronic control units may successively transmit a frame of a specific type containing data generated based on a result of the sensing of the first sensor. That is, the plurality of electronic control units may include the second electronic control unit that is different from the first electronic control unit, and the frame may include the frame of the specific type that is transmitted by the second electronic control unit. Furthermore, the frame of the specific type may contain, as the data, data generated based on a result of the sensing of the first sensor. The acquisition unit may acquire the sensor information from the data contained in the frame of the specific type. For example, in a case where the content of the first-type frame and the sensor information based on the frame of the specific type are in disagreement with each other, this configuration makes it possible to presumptively determine that the content of the first-type frame is illegal without identifying which of the frames is illegal. For an attacker who controls or spoofs the first electronic control unit to transmit an illegal first-type frame, it is not necessarily easy to, for example, simultaneously control the second electronic control unit to transmit the frame of the specific type; thus, this configuration may be useful.

Furthermore, for example, the first sensor may be connected to the information processing device via an exclusive line that is a wire exclusively used for communication with the information processing device. The acquisition unit may acquire the sensor information that is transmitted from the first sensor over the exclusive line. This configuration allows the information processing device to acquire the sensor information over the exclusive line, which makes it possible to assume that the sensor information is trustworthy to a certain degree and appropriately determine whether the content of the first-type frame is illegal based on the trustworthiness. For an attacker who controls or spoofs the first electronic control unit to transmit an illegal first-type frame over a network where electronic control units communicate with each other, it is not necessarily easy to simultaneously make an attack, for example, altering the sensor information transmitted over the exclusive line; thus, the information processing device thus configured may be useful.

Furthermore, for example, the acquisition unit may acquire, over the network, the sensor information from an electronic control unit of the plurality of electronic control units that is connected with the first sensor over an exclusive line that is a wire exclusively used for communication with the first sensor. This configuration makes it possible to assume that the sensor information acquired from the first sensor via the electronic control unit is also trustworthy to a certain degree.

Furthermore, the information processing method according to one aspect of the present disclosure is used in an information processing device connected to a network where a plurality of electronic control units perform communication. The information processing method includes receiving a frame containing data over the network, acquiring sensor information obtained by sensing of a first sensor, and determining whether the data is illegal based on the sensor information. This configuration allows determination whether a frame is illegal to be made even on a frame that cannot be determined whether the frame is illegal based on a specific value. This determination allows appropriate handling of an attack frame.

Furthermore, a non-transitory computer readable recording medium according to one aspect of the present disclosure contains a program that causes an information processing device to execute a specific information process, the information processing device including a microprocessor and being connected to a network where a plurality of electronic control units perform communication. The specific information process includes receiving a frame containing data over the network, acquiring sensor information obtained by sensing of a first sensor, and determining whether the data is illegal based on the sensor information. This program is installed in the information processing device, and the microprocessor of the information processing device executes the program, which in turn causes the specific information process to be performed. This configuration allows determination whether a frame is illegal to be made even on a frame that cannot be determined whether the frame is illegal based on a specific value.

It should be noted that those comprehensive or specific aspects may be implemented by a system, a method, an integrated circuit, a computer program, or a computer readable recording medium such as a compact disc read-only memory (CD-ROM), or may be implemented by any combination of the system, the method, the integrated circuit, the computer program, and the recording medium.

Hereinafter, a description will be given of an in-vehicle network system including an information processing device that uses an information processing method according to exemplary embodiments with reference to the drawings. Note that the exemplary embodiments described below each illustrate a specific example of the present disclosure. Numerical values, constituent components, arrangement positions and connection modes of the constituent components, steps, order of the steps, and the like illustrated in the following exemplary embodiments are merely examples, and therefore are not intended to limit the present disclosure. Among the constituent components in the following exemplary embodiments, constituent components not recited in the independent claim can be added as appropriate. It should be noted that each of the diagrams is schematic, and is not necessarily strictly accurate. The following exemplary embodiments are described as a security measure in an in-vehicle network system mounted on a vehicle. However, a scope of application is not limited to this. It may be applied to other mobilities such as a construction machine, a farming machine, a vessel, a railway, an aircraft, as well as a vehicle.

### First Exemplary Embodiment

[1.1 Overall Configuration of in-Vehicle Network System 10]

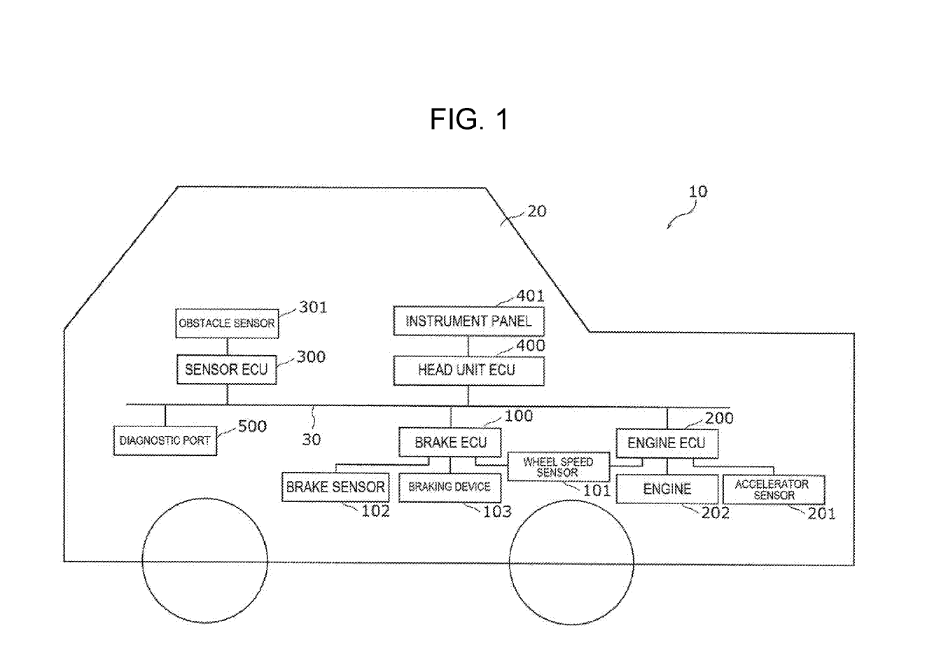

FIG. 1 is a diagram illustrating an overall configuration of in-vehicle network system 10 according to the present exemplary embodiment.

In-vehicle network system 10 is an example of a network communication system that performs communication in accordance with the CAN protocol and includes an in-vehicle network of vehicle 20. Vehicle 20 is, for example, a motor vehicle on which various devices, such as an actuator, a controller, and a sensor are mounted.

In-vehicle network system 10 includes bus (network bus) 30, brake ECU 100, engine ECU 200, sensor ECU 300, head unit ECU 400, diagnostic port 500, wheel speed sensor 101, brake sensor 102, braking device 103, accelerator sensor 201, engine 202, obstacle sensor 301, and instrument panel 401. Although not illustrated in FIG. 1, in-vehicle network system 10 may further include a number of ECUs in addition to brake ECU 100, engine ECU 200, sensor ECU 300, and head unit ECU 400. For the sake of convenience of description, the description will focus on brake ECU 100, engine ECU 200, sensor ECU 300, and head unit ECU 400, herein.

Each ECU (for example, brake ECU 100, engine ECU 200, sensor ECU 300, and head unit ECU 400) includes, for example, a processor (that is, a microprocessor), a digital circuit such as a memory, an analog circuit, and a communication circuit as hardware. The memory includes, for example, a read-only memory (ROM), a random access memory (RAM) and is capable of storing a program (that is, a computer program) to be executed by the processor. Each ECU, that is, the processor thereof, operates in accordance with the program to achieve various functions such as control of vehicle 20. Such a program is a set of a plurality of instruction codes that each indicate an instruction applied to the processor, in order to achieve a specific function.

Each ECU is connected to bus 30 to from an in-vehicle network. Furthermore, each ECU may be connected with a device such as an actuator, a controller, or a sensor. Each ECU transmits and receives a frame over bus 30 in accordance with the CAN protocol. For example, an ECU connected to the sensor periodically transmits, over bus 30, a data frame containing data based on information acquired by the sensor. The transmission interval of a frame varies depending on data frequency required for each ECU in the system, for example, from several ten milliseconds to several hundred milliseconds. Furthermore, an ECU connected to the actuator in vehicle 20 determines control content for the actuator based on a data frame received over bus 30 and then controls the actuator. Each ECU connected to bus 30 is capable of receiving any type of data frame transmitted over bus 30 and is configured to selectively receive and handle a data frame of a specific type that is predetermined for each ECU.

Brake ECU 100 is connected to wheel speed sensor 101, brake sensor 102, and braking device 103 over respective exclusive lines. Unlike bus 30 where a plurality of ECUs perform communication in accordance with the CAN protocol, the exclusive line is not used for communication between the plurality of ECUs. The exclusive line is a wire used only for predetermined bilateral communication, such as communication between brake ECU 100 and wheel speed sensor 101 or communication between brake ECU 100 and brake sensor 102. The exclusive line requires a connection, such as a one-to-one communication line, that is more reliable than a bus. This is also applied to the following exclusive lines.

Wheel speed sensor 101 is a sensor (for example, aggregation of sensors) that performs sensing of a wheel speed and is configured to output, as a sensing result, sensor information indicating a wheel speed resulting from, for example, measurement made by each sensor of a rotational speed (rpm) of each of the wheels of vehicle 20. The wheel speed as the sensing result from the wheel speed sensor 101 corresponds to, for example, the average of respective rotational speeds of wheels of vehicle 20. Brake sensor 102 performs sensing on an operation of a brake pedal. Braking device 103 controls a brake actuator under control of brake ECU 100 to regulate a speed of vehicle 20.

Brake ECU 100 is capable of transmitting a data frame over bus 30 based on respective sensing results received from wheel speed sensor 101 and brake sensor 102 and controlling braking device 103 in accordance with a data frame received over bus 30 or the sensing result from brake sensor 102. Brake ECU 100 is further capable of serving as an information processing device that performs an illegal frame determination process. The information processing device implemented in brake ECU 100 makes, as the illegal frame determination process, determination whether a determination target frame of a specific type on bus 30 is illegal based on sensor information indicating a wheel speed corresponding to a sensing result of wheel speed sensor 101 and performs a specific process when the frame is illegal.

Engine ECU 200 is connected to wheel speed sensor 101, accelerator sensor 201, and engine 202 via respective exclusive lines. Accelerator sensor 201 performs sensing on an operation of an accelerator pedal. Engine 202 opens and closes a throttle valve to control a rotational speed of engine 202 under control of engine ECU 200.

Engine ECU 200 is capable of transmitting, over bus 30, a data frame based on respective sensing results received from wheel speed sensor 101 and accelerator sensor 201 and controlling engine 202 in accordance with the sensing result from accelerator sensor 201.

Sensor ECU 300 is connected to obstacle sensor 301 via an exclusive line. Obstacle sensor 301 includes one or a plurality of sensors that perform sensing on a road in a travelling direction of vehicle 20, and no limit is imposed on a number of the sensors. For the sensing on a road in the travelling direction, for example, a light detection and ranging (LIDAR) such as an infrared laser sensor, an image sensor, and a radar are used. For example, obstacle sensor 301 performs sensing on a road in the travelling direction (for example, in front of) vehicle 20 and transmits, to sensor ECU 300, a sensing result indicating, for example, presence or absence of an obstacle and coordinates of the obstacle.

Sensor ECU 300 is capable of transmitting, over bus 30, a data frame based on a sensing result received from obstacle sensor 301. Sensor ECU 300 is further capable of, for an emergency braking function of the ADAS, transmitting a data frame related to an instruction applied to brake ECU 100 based on a data frame received over bus 30 and a sensing result from obstacle sensor 301.

Head unit ECU 400 is connected to instrument panel 401 via an exclusive line. Instrument panel 401 displays various types of information for a driver of vehicle 20. Head unit ECU 400 is capable of, for example, causing instrument panel 401 to display information based on a data frame received over bus 30. For example, upon receiving an abnormality notification frame that is a data frame of a predetermined type, indicating an abnormality, head unit ECU 400 may cause instrument panel 401 to display information indicating the abnormality.

Diagnostic port 500 is a terminal that is compatible with, for example, on-board diagnostics 2 (OBD2) and is connected to bus 30. Diagnostic port 500 allows a device such as a diagnostic tool (fault diagnostic tool) to access bus 30. Such a diagnostic tool is capable of receiving, for example, a diagnostic code recorded as a log from an in-vehicle fault diagnostic device (not illustrated). An attacker may transmit an illegal data frame over bus 30 via, for example, diagnostic port 500. Furthermore, the attacker may attack an ECU (not illustrated) capable of communicating with a device such as a handheld information terminal or a communication device located outside a vehicle to control the ECU and then transmit an illegal data frame over bus 30.

In in-vehicle network system 10, each ECU transmits and receives a frame such as a data frame in accordance with the CAN protocol. Frames of the CAN protocol include a data frame, a remote frame, an overload frame, and an error frame. Herein, a description will mainly focus on the data frame and the error frame.

### [1.2 Data Frame Format]

Hereinafter, a description will be given of the data frame, which is one of the frames used in a network in accordance with the CAN protocol.

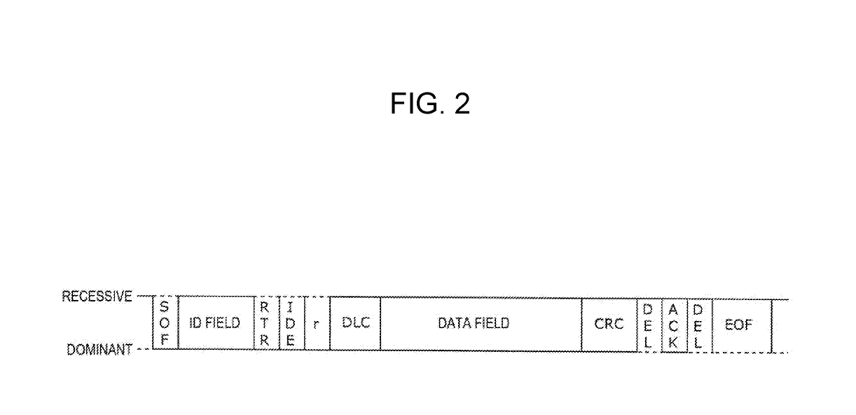

FIG. 2 is a diagram illustrating a format of a data frame specified in the CAN protocol. In FIG. 2, a data frame in the format with standard ID specified in the CAN protocol is illustrated. The data frame includes different fields: Start Of Frame (SOF), ID field, Remote Transmission Request (RTR), Identifier Extension (IDE), reserved bit “r”, Data Length Code (DLC), data field, Cyclic Redundancy Check (CRC) sequence, CRC delimiter “DEL”, Acknowledgement (ACK) slot, ACK delimiter “DEL”, and End Of Frame (EOF).

The SOF is formed of a single dominant bit. When the bus is idle that is a recessive level, a transition from recessive to dominant using the SOF to make notification of the start of a frame transmission.

The ID field is a field of 11 bits that contains an ID that is a value indicating a type of data. The CAN protocol is designed to allow communication arbitration with the ID field such that a frame having a smaller ID value has higher priority when a plurality of nodes simultaneously start transmission.

The RTR is a value for distinguishing the data frame and the remote frame. In the data frame, the RTR is formed of a single dominant bit.

Each of the IDE and “r” is formed of a single dominant bit.

The DLC is formed of 4 bits and contains a value indicating a length of the data field. Note that the IDE, “r”, and the DLC will be collectively referred to as a control field.

The data field is formed of up to 64 bits and contains a value indicating content of transmission data. The length of the data field is variable with 8-bit alignment. Transmission data is not specified in the CAN protocol, but specified for each in-vehicle network system. The specifications of the transmission data, therefore, depend on a vehicle model, a manufacturer (manufacturing maker), and the like.

The CRC sequence is 15 bits long. The CRC sequence is derived from values to be transmitted in the SOF, the ID field, the control field, and the data field.

The CRC delimiter is a delimiter of a single recessive bit that indicates an end of the CRC sequence. Note that the CRC sequence and the CRC delimiter will be collectively referred to as a CRC field.

The ACK slot is formed of a single bit. A transmitting node performs transmission with the ACK slot made recessive. Upon successfully receiving data up to the CRC sequence, a receiving node performs transmission with the ACK made dominant. Because a dominant bit prevails over a recessive bit, when the ACK slot is dominant after the transmission, the transmitting node can confirm that any receiving node has successfully received the data frame.

The ACK delimiter is a delimiter of a single recessive bit that indicates an end of the ACK.

The EOF is formed of 7 recessive bits and indicates an end of the data frame.

### [1.3 Error Frame Format]

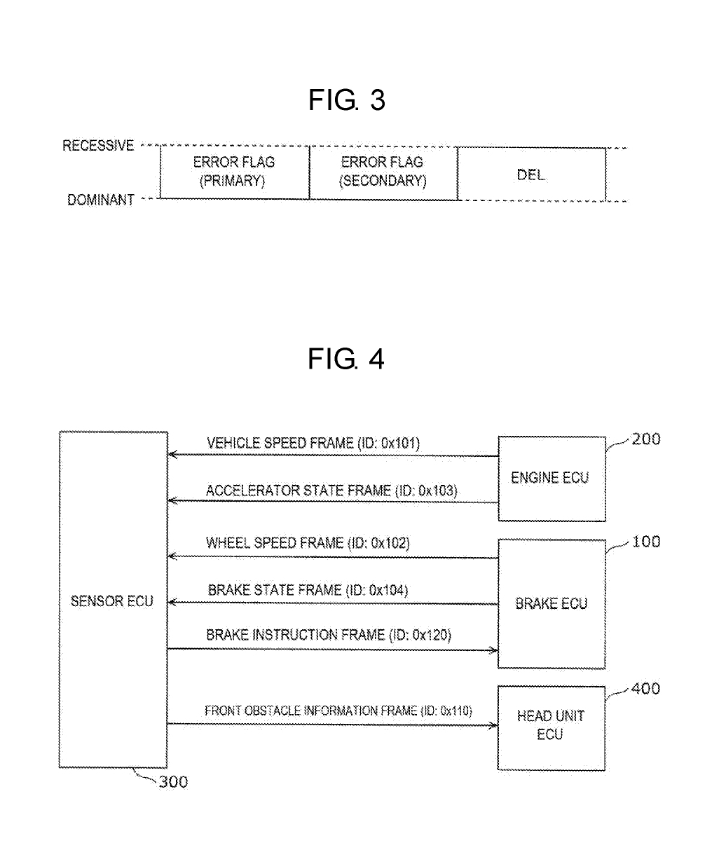

FIG. 3 is a diagram illustrating a format of an error frame specified in the CAN protocol. The error frame includes an error flag (primary), an error flag (secondary), and an error delimiter.

The error flag (primary) is used for signaling the other nodes of occurrence of an error. A node that has detected an error transmits 6 consecutive dominant bits to signal the other nodes of occurrence of the error. This transmission violates the rule of bit stuffing (not allowed to transmit 6 or more consecutive bits of identical value) of the CAN protocol, which causes the other nodes to transmit the error flag (secondary).

The error flag (secondary) is formed of 6 consecutive dominant bits used for signaling the other nodes of occurrence of an error. All the other nodes that have received the error flag (primary) and detected the violation of the rule of bit stuffing are to transmit the error flag (secondary).

The error delimiter “DEL” is formed of 8 consecutive recessive bits and indicates an end of the error frame.

### [1.4 Frame to be Transmitted and Received for Emergency Braking Function]

FIG. 4 illustrates examples of frames to be transmitted and received between ECUs for an emergency braking function of the ADAS of vehicle 20.

Engine ECU 200 successively transmits a vehicle speed frame and an accelerator state frame over bus 30. The vehicle speed frame is a data frame containing, in the data field, data indicating a vehicle speed as a state of the vehicle and an ID of “0x101”. In a normal state, engine ECU 200 sets, in the vehicle speed frame, data indicating a vehicle speed (km/h) generated based on a wheel speed (that is, a wheel speed resulting from sensing of wheel speed sensor 101) acquired from wheel speed sensor 101. The accelerator state frame is a data frame containing, in the data field, data on the operation of the accelerator pedal and an ID of “0x103”.

Brake ECU 100 transmits a wheel speed frame and a brake state frame over bus 30. The wheel speed frame is a data frame containing, in the data field, data indicating a wheel speed and an ID of “0x102”. Brake ECU 100 sets, in the wheel speed frame, data indicating the wheel speed acquired from wheel speed sensor 101. The brake state frame is a data frame containing, in the data field, data on the operation of the brake pedal and an ID of “0x104”.

Sensor ECU 300 receives the vehicle speed frame, the accelerator state frame, the wheel speed frame, and the brake state frame over bus 30. Sensor ECU 300 calculates, from the vehicle speed frame received and the sensing result from obstacle sensor 301, a deceleration amount for braking control of vehicle 20 using specific algorithm and transmits, over bus 30, a braking instruction frame containing the deceleration amount. For example, in a case where an obstacle that cannot be avoided by steering control and the like is detected in front of vehicle 20 and the vehicle speed of vehicle 20 is not zero, sensor ECU 300 determines to activate emergency braking and calculates the deceleration amount such that vehicle 20 is sufficiently decelerated.

Note that sensor ECU 300 temporarily stores the received frames into a data buffer corresponding to, for example, a region of the memory for efficient processing and can retrieve the frames from the data buffer at a timing synchronized with transmission intervals of the braking instruction frame. The braking instruction frame is a data frame containing, in the data field, data indicating the deceleration amount and an ID of “0x120”. Brake ECU 100 can control braking device 103 and the like in accordance with the deceleration amount in the braking instruction frame.

Furthermore, sensor ECU 300 transmits a front obstacle information frame over bus 30. The front obstacle information frame is a data frame containing, in the data field, data indicating, for example, presence or absence of an obstacle based on the sensing result from obstacle sensor 301 and an ID of “0x110”.

Head unit ECU 400 causes instrument panel 401 to display information on an obstacle based on data indicating, for example, presence or absence of the obstacle in the front obstacle information frame. Head unit ECU 400 may receive, for example, the vehicle speed frame and cause instrument panel 401 to display information based on the content of the vehicle speed frame.

### [1.5 Configuration of Brake ECU 100]

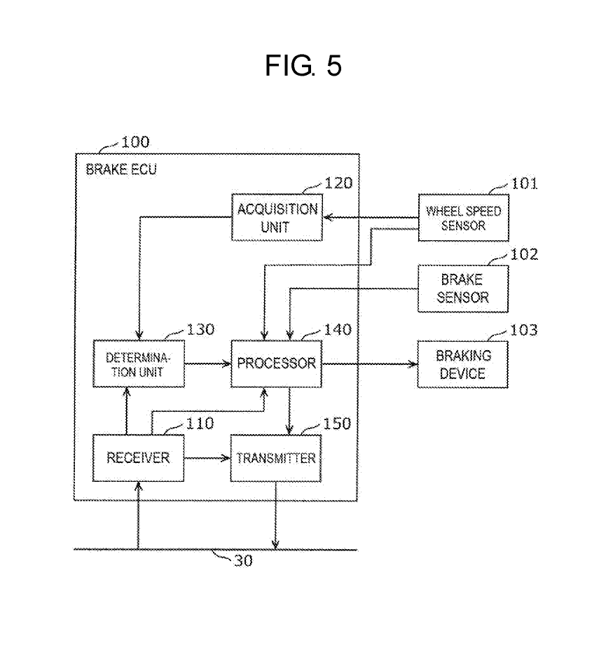

FIG. 5 is a block diagram of brake ECU 100. FIG. 5 includes wheel speed sensor 101, brake sensor 102, and braking device 103 that are directly connected, via respective exclusive lines, to brake ECU 100.

Brake ECU 100 that controls, for example, braking device 103 is capable of serving as an information processing device that performs an illegal frame determination process, such as determination on a determination target frame of a specific type. Herein, the description will be given on the assumption that the determination target frame of a specific type corresponds to the vehicle speed frame.

Brake ECU 100 includes receiver 110, acquisition unit 120, determination unit 130, processor 140, and transmitter 150.

Receiver 110 and transmitter 150 are implemented by an integrated circuit (for example, a communication circuit, a memory, and a processor) that controls communication over bus 30. Receiver 110 and transmitter 150 receive and transmit a frame in accordance with the CAN protocol. Receiver 110 receives a frame over the in-vehicle network, that is, bus 30, and transmitter 150 transmits a frame over bus 30.

To be more specific, receiver 110 successively receives, over bus 30, a value of the frame one bit by one bit and interprets the value by mapping the value to the fields in the frame format specified in the CAN protocol. Receiver 110 determines whether a value determined to be an ID field corresponds to an ID to be received by brake ECU 100 and terminates the interpretation of the frame when the value is not the ID to be received by brake ECU 100. The ID to be received is, for example, the ID of “0x120” in the braking instruction frame or the ID of “0x101” in the vehicle speed frame that is a determination target frame of a specific type. Note that in a case where, for example, receiver 110 determines that a frame received does not comply with the CAN protocol, receiver 110 causes transmitter 150 to transmit an error frame. Furthermore, in a case where receiver 110 receives an error frame, that is, receiver 110 interprets a frame received as an error frame from a value contained in the frame, receiver 110 discards the frame thereafter. Receiver 110 transmits content of the frame thus interpreted to determination unit 130 and transmits content of the braking instruction frame to processor 140.

Acquisition unit 120 acquires sensor information indicating a result of sensing performed by wheel speed sensor 101, the sensor information being transmitted from wheel speed sensor 101 over an exclusive line. Acquisition unit 120 is implemented in brake ECU 100 by, for example, a communication circuit for communication with wheel speed sensor 101 over an exclusive line, and a processor that executes a program, and a memory. Acquisition unit 120 may repeatedly acquire the sensor information. Acquisition unit 120 may hold the sensor information acquired in, for example, a buffer (for example, a region of the memory) and manage the sensor information with a term of validity that is a certain period after the acquisition of the sensor information (for example, several hundred milliseconds). With such management of the term of validity, acquisition unit 120 may acquire, from wheel speed sensor 101, new sensor information in a case where sensor information needs to be checked and the term of validity of the latest sensor information already acquired has expired. Furthermore, acquisition unit 120 may repeatedly acquire, from wheel speed sensor 101, the sensor information at constant intervals (for example, intervals ranging from several ten milliseconds to several hundred milliseconds).

Determination unit 130 is implemented by, for example, a processor that executes a program. Determination unit 130 determines, in accordance with a predetermined determination condition, whether the content of the frame received by receiver 110 is illegal based on the sensor information acquire by acquisition unit 120. Determination unit 130 may determine whether the content of the vehicle speed frame received by receiver 110 is illegal based on the latest sensor information acquired by acquisition unit 120, the latest sensor information having the term of validity that has not expired.

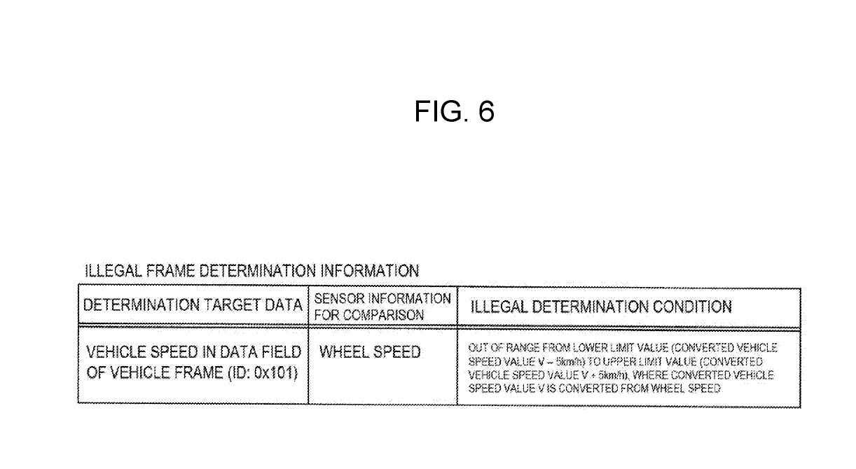

FIG. 6 illustrates an example of information for illegal frame determination, indicating the determination condition used by determination unit 130. The information for illegal frame determination corresponds to information in which determination target data, sensor information for comparison, and an illegality determination condition are associated with each other. The determination target data is used for identifying a determination target frame and data corresponding to the content of the determination target frame that are to be determined by determination unit 130. The determination target data can contain information indicating a position, in a frame, of data to be determined. The sensor information for comparison is used for identifying the source of sensor information to be compared with data identified by the determination target data, that is, for identifying which of the sensors has generated the sensor information as a sensing result. The illegality determination condition indicates a condition under which a relationship between the data identified by the determination target data and the sensor information identified by the sensor information for comparison is determined illegal due to that the data and the sensor information are in disagreement with each other.

The information for illegal frame determination illustrated as an example in FIG. 6 indicates that a frame containing the ID of “0x101” (that is, the vehicle speed frame) is to be a determination target frame. Furthermore, the information for illegal frame determination indicates that determination is to be made by comparing vehicle speed data in a predetermined specific position in the vehicle speed frame (that is, vehicle speed data in the data field) with sensor information on a wheel speed that is a sensing result of the wheel speed sensor. Furthermore, the information for illegal frame determination indicates that a value indicated by the vehicle speed data is determined to be illegal when the value is out of a range from a lower limit value and an upper limit value specified by sensor information on the wheel speed. The lower limit value is calculated from converted vehicle speed value V−a margin value (for example, 5 km/h), and the upper limit value is calculated from converted vehicle speed value V+the margin value, where converted vehicle speed value V is a result (a first-type physical quantity or parameter of a first type) of conversion of the wheel speed (rpm) indicated by, for example, the sensor information into the vehicle speed (km/h).

Specifically, determination unit 130 determines whether data (hereinafter referred to as vehicle speed data) indicating a vehicle speed (a second-type physical quantity or a parameter of a second type) contained in a predetermined specific position (that is, the data field) in the vehicle speed frame received by receiver 110 is illegal based on the sensor information acquired by acquisition unit 120 from wheel speed sensor 101. Then, determination unit 130 determines that the value indicated by the vehicle speed data contained in the vehicle speed frame received by receiver 110 is illegal when the value is out of the range from the lower limit value and the upper limit value specified based on the sensor information acquired by acquisition unit 120. Otherwise, determination unit 130 determines that the value is not illegal (that is, the value is appropriate). For example, the lower limit value corresponds to converted vehicle speed value V−5 km/h, and the upper limit value corresponds to converted vehicle speed value V+5 km/h, converted vehicle speed value V being converted from the wheel speed. Determination unit 130 notifies processor 140 of the determination result.

Upon receiving the content of the braking instruction frame from receiver 110, processor 140 transmits a control signal to braking device 103 to control braking device 103 in accordance with the deceleration amount indicated by the content of the braking instruction frame. Processor 140 activates braking device 103 such that, for example, the larger the deceleration amount indicated by the content of the braking instruction frame is, the greater force (braking force) is applied. Processor 140 deactivates braking device 103 when receiver 110 receives, for example, the braking instruction frame containing the deceleration amount set to zero. Furthermore, processor 140 controls braking device 103 based on a sensing result of brake sensor 102 in response to a driver's operation on the brake pedal of vehicle 20. Processor 140 may prioritize the control of braking device 103 based on the sensing result of brake sensor 102 over the control of braking device 103 based on the braking instruction frame.

Furthermore, based on a notification of determination result from determination unit 130, processor 140 executes a specific process set beforehand for handling an abnormal state when determination unit 130 determines that the content of the vehicle speed frame is illegal and does not execute the specific process when determination unit 130 does not determine that the content of the vehicle speed frame is illegal. The specific process corresponds to a process for preventing a transfer of a vehicle speed frame determined to be illegal. For example, in a case where determination unit 130 determines that the content of the vehicle speed frame is illegal, processor 140 may transmit, over bus 30, the error frame via transmitter 150 before receiver 110 receives the last bit of the vehicle speed frame. Thus, determination unit 130 may determine whether the content of the vehicle speed frame is illegal and notify processor 140 of the determine result before receiver 110 receives the last bit of the vehicle speed frame. When the error frame is transmitted with the vehicle speed frame on bus 30, the vehicle speed frame is overridden, and each ECU connected to bus 30 discards the vehicle speed frame.

Furthermore, the specific process executed by processor 140 may include a process for notifying a driver of a vehicle of an abnormality and a process for recording the abnormality into a recording medium in addition to the process for preventing the vehicle speed frame determined to be illegal from being transferred. The process for recording the abnormality corresponds to, for example, a process for recording, into an in-vehicle fault diagnostic device (not illustrated), a diagnostic code and the like associated with the abnormality as a log. Furthermore, the process for notifying the driver of the vehicle of the abnormality corresponds to, for example, a process for transmitting an abnormality notification frame of a predetermined type indicating the abnormality via transmitter 150 over bus 30 such that head unit ECU 400 that controls instrument panel 401 receives the abnormality notification frame.

### [1.6 Illegal Frame Determination Process Performed by Brake ECU 100]

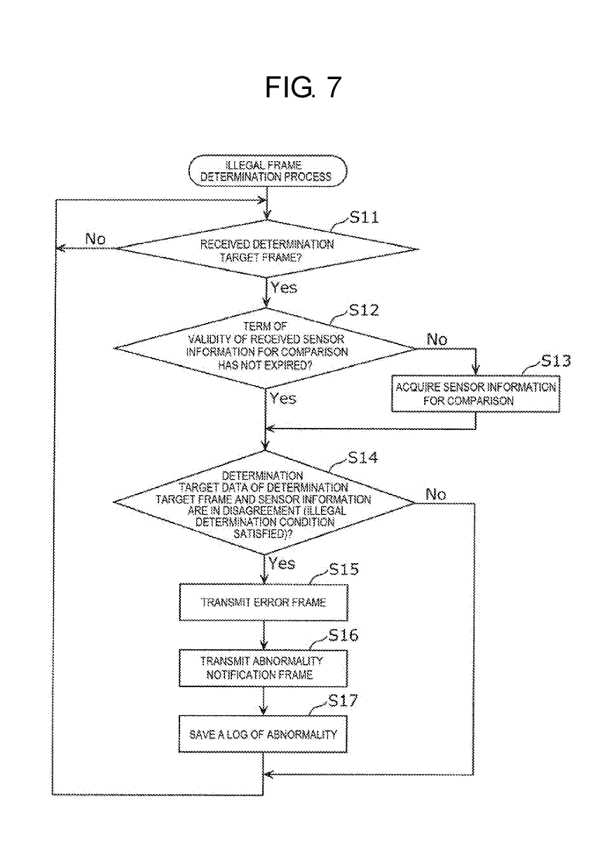

FIG. 7 is a flowchart illustrating an example of the illegal frame determination process performed by brake ECU 100. Hereinafter, a description will be give of the illegal frame determination process with reference to FIG. 7. Herein, the description will be given on the assumption that determination unit 130 of brake ECU 100 makes determination based on the information for illegal frame determination illustrated in FIG. 6.

Brake ECU 100 first waits for reception of a vehicle speed frame that is a determination target frame in step S11. In a case where the determination target frame is not received (No in step S11), brake ECU 100 continues to wait for reception of the determination target frame. In a case where brake ECU 100 receives the vehicle speed frame that is the determination target frame via receiver 110 (Yes in step S11), brake ECU 100 determines whether a term of validity of the latest sensor information for comparison acquired by acquisition unit 120 (that is, sensor information on a wheel speed acquired from wheel speed sensor 101) has expired (step S12). In a case where the term of validity has expired (No in step S12), acquisition unit 120 acquires sensor information for comparison from wheel speed sensor 101 (step S13). In a case where the determination is made that the term of validity has not expired in step S12 (Yes in step S12) or new sensor information for comparison is acquired in step S13, the latest sensor information whose term of validity has not expired is held in a buffer by acquisition unit 120 and then the process proceeds to step S14.

Brake ECU 100 causes determination unit 130 to determine whether the content of the determination target frame is illegal based on whether the determination target data (that is, vehicle speed data) contained in the determination target frame and the latest sensor information whose term of validity has not expired are in disagreement with each other (that is, the illegality determination condition illustrated in FIG. 6 is satisfied) (step S14).

In a case where determination is made in step S14 that there is disagreement, that is, the content of the determination target frame is illegal (Yes in step S14), brake ECU 100 causes processor 140 to transmit the error frame over bus 30 via transmitter 150 (step S15). After step S15, processor 140 transmits the abnormality notification frame over bus 30 via transmitter 150 (step S16), and records a log of the abnormality (step S17). In step S17, processor 140 may record, for example, a diagnostic code associated with the abnormality into an in-vehicle fault diagnostic device. Note that, herein, after the transmission of the error frame in step S15, the transmission of the abnormality notification frame in step S16 and the recording of the log of the abnormality in step S17 are performed, but this is merely an example, and it should be easily understood by those skilled in the art that an illegal frame may be handled with only the transmission of the error frame in step S15 or a combination of other processes.

Furthermore, in a case where determination is made in step S14 that there is no disagreement, that is, the content of the determination target frame is appropriate, brake ECU 100 skips steps S15 to S17 and returns to step S11 to wait for reception of a determination target frame.

### [1.7 Cooperative Operation of ECUs for Emergency Braking Function]

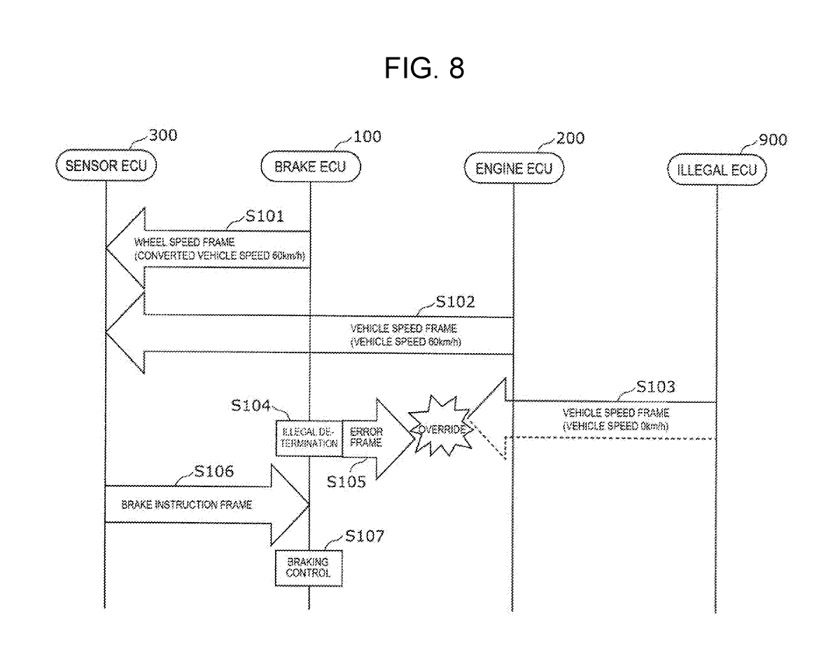

FIG. 8 is a diagram illustrating an example of a process sequence among a plurality of ECUs that cooperate with each other for the emergency braking function. In this example, a vehicle speed frame falsified by an attacker to indicate that a vehicle speed from illegal ECU 900 is zero is transmitted over bus 30 in a situation where an obstacle that cannot be avoided by steering control and the like is detected in front of vehicle 20 that is travelling and emergency braking should be activated. Illegal ECU 900 controlled by the attacker is an ECU that can access bus 30 including, for example, an ECU connected by the attacker to diagnostic port 500 or an ECU taken over due to an illegal attack to, for example, a gateway.

In step S101, brake ECU 100 transmits, over bus 30, a wheel speed frame indicating a wheel speed equivalent to a vehicle speed of 60 km/h converted from a wheel speed acquired from wheel speed sensor 101. The wheel speed frame is received by sensor ECU 300.

Next, in step S102, engine ECU 200 transmits, over bus 30, a vehicle speed frame containing, in the data field, vehicle speed data that is generated based on the wheel speed acquired from wheel speed sensor 101 and indicates 60 km/h. The vehicle speed frame is received by sensor ECU 300.

Next, in step S103, illegal ECU 900 transmits, over bus 30, a vehicle speed frame containing vehicle speed data falsified to indicate a vehicle speed of zero (0 km/h). This is an attack that overwrites the vehicle speed frame indicating a vehicle speed of 60 km/h with the vehicle speed frame falsified to indicate a vehicle speed of 0 km/h in (the data buffer of) sensor ECU 300 to cause sensor ECU 300 to erroneously recognize that vehicle 20 is at a stop, which prevents activation of the emergency braking.

Brake ECU 100 makes determination on, as a determination target frame, a vehicle speed frame based on sensor information on a wheel speed. In step S103, a wheel speed indicated by the latest sensor information acquired by the brake ECU 100 is equivalent to a vehicle speed of 60 km/h. Thus, brake ECU 100 determines in step S104 that the vehicle speed frame is illegal because the vehicle speed data falsified to indicate a vehicle speed of 0 km/h is out of the range from the lower limit value of 55 km/h to the upper limit value of 65 km/h specified in the illegality determination condition (refer to FIG. 6).

Then, in step S105, brake ECU 100 transmits the error frame. This causes part of the vehicle speed frame containing the vehicle speed data falsified to indicate a false vehicle speed to be overwritten with the error frame. This causes the vehicle speed frame falsified to indicate a false vehicle speed to be overridden and discarded in sensor ECU 300.

Sensor ECU 300 that has discarded the vehicle speed frame falsified to indicate a false vehicle speed calculates, in step S106, a deceleration amount necessary for activation of the emergency braking based on, for example, a sensing result of obstacle sensor 301 and the vehicle speed data received in step S102 that indicates 60 km/h and transmits, over bus 30, a braking instruction frame indicating the deceleration amount.

Next, in step S107, brake ECU 100 performs braking control on braking device 103 in accordance with the deceleration amount indicated by the braking instruction frame.

### [1.8 Effects of First Exemplary Embodiment]

In in-vehicle network system 10 according to the first exemplary embodiment, brake ECU 100 determines whether the content of the vehicle speed frame indicating a vehicle speed is illegal based on agreement between the content and sensor information for comparison that corresponds to sensor information on a wheel speed acquired from wheel speed sensor 101 over the exclusive line. In a case where the determine result indicates that the content is illegal, brake ECU 100 performs a specific process such as transmission of the error frame.

The above-described determination is valid on the assumption that the sensor information for comparison and the content of the determination target frame have a certain relationship. That is, the above-described determination made by brake ECU 100 based on the sensor information acquired over the exclusive line from wheel speed sensor 101 is valid in in-vehicle network system 10 in which engine ECU 200 transmits a vehicle speed frame containing vehicle speed data generated, in a normal state, based on a sensing result from wheel speed sensor 101. In a case where an illegal vehicle speed frame falsified by an attacker to indicate a false vehicle speed is transmitted over bus 30, the content of the vehicle speed frame and the sensor information for comparison are in disagreement with each other, which allows brake ECU 100 to determine that the vehicle speed frame is illegal and appropriately handle the illegal frame.

### (Modification of First Exemplary Embodiment)

Hereinafter, a description will be given of an example in which the illegal frame determination process performed by brake ECU 100 in in-vehicle network system 10 in the first exemplary embodiment is partially modified. In this illegal frame determination process according to the modification of the first exemplary embodiment, determination on a vehicle speed frame corresponding to a determination target frame previously received is made at a timing when the braking instruction frame is received. That is, determination unit 130 of brake ECU 100 determines whether data contained in the latest vehicle speed frame already received by receiver 110 is illegal based on sensor information acquired from wheel speed sensor 101 when receiver 110 receives the braking instruction frame indicating an instruction to perform braking control.

### [1.9 Illegal Frame Determination Process According to Modification]

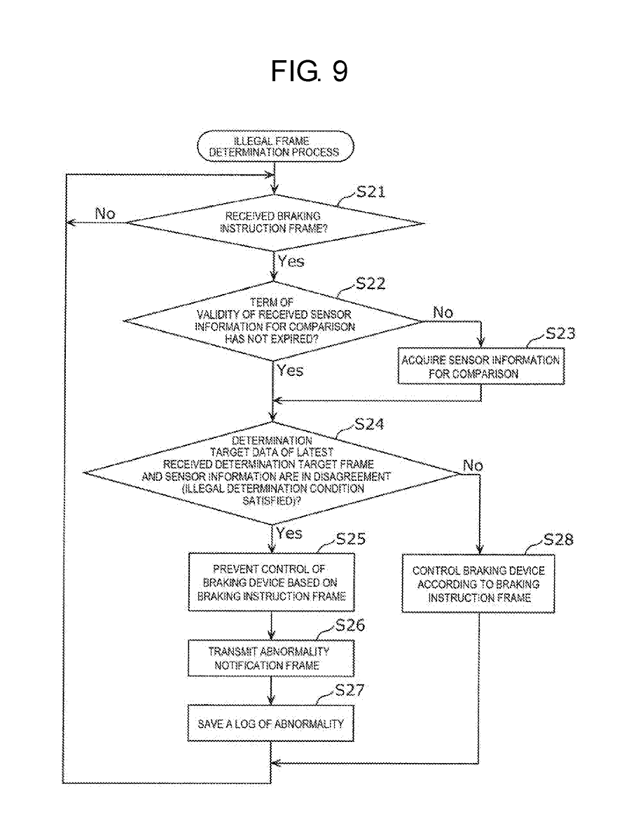

FIG. 9 is a flowchart illustrating an example of an illegal frame determination process performed by brake ECU 100 according to the modification of the first exemplary embodiment. Hereinafter, a description will be given of the illegal frame determination process according to the modification with reference to FIG. 9. Herein, the description will be given on the assumption that determination unit 130 of brake ECU 100 makes determination based on the information for illegal frame determination illustrated in FIG. 6. Furthermore, upon receiving a vehicle speed frame corresponding to the determination target frame via receiver 110, brake ECU 100 temporarily holds the vehicle speed frame in a data buffer corresponding to a region of the memory.

Brake ECU 100 waits for reception of the braking instruction frame (No in step S21). Upon receiving the braking instruction frame from receiver 110 (Yes in step S21), brake ECU 100 determines whether a term of validity of the latest sensor information for comparison already acquired by the acquisition unit 120 (that is, sensor information acquired from wheel speed sensor 101) has expired (step S22). In a case where the term of validity has expired (No in step S22), acquisition unit 120 acquires sensor information for comparison from wheel speed sensor 101 (step S23). In a case where the term of validity has not expired in step S22 (Yes in step S22) or new sensor information for comparison is acquired in step S23, the latest sensor information whose term of validity has not expired is held in the buffer by acquisition unit 120 and the process proceeds to step S24.

Brake ECU 100 causes determination unit 130 to determine whether the content of the determination target frame is illegal based on whether the determination target data (that is, vehicle speed data) contained in the latest determination target frame already received and held in data buffer and the latest sensor information whose term of validity has not expired are in disagreement with each other (that is, the illegality determination condition illustrated in FIG. 6 is satisfied) (step S24).

In a case where determination is made in step S24 that there is disagreement, that is, the content of the determination target frame is illegal (Yes in step S24), brake ECU 100 prevents processor 140 from controlling braking device 103 based on the braking instruction frame received in step S21 (step S25). Then, processor 140 of brake ECU 100 transmits, over bus 30, the abnormality notification frame via transmitter 150 (step S26) and records a log of the abnormality (step S27). Processes of step S26, S27 are respectively identical to the processes of step S16, S17 according to the first exemplary embodiment. Note that, herein, after the prevention of control of braking device 103 in step S25, the transmission of the abnormality notification frame in step S26 and the recording of the log of the abnormality in step S27 are performed, but this is merely an example, and it should be easily understood by those skilled in the art that an illegal frame may be handled with only the prevention of control of braking device 103 in step S25 or a combination of other processes.

Furthermore, in a case where determination is made in step S24 that there is no disagreement, that is, the content of the determination target frame is appropriate (No in step S24), brake ECU 100 controls braking device 103 based on the braking instruction frame received in step S21 (step S28). Note that, in step S28, in a case where a vehicle speed of vehicle 20 is high (for example, 70 km/h or higher), brake ECU 100 is allowed to not perform braking control (that is, control of braking device 103) based on the braking instruction frame.

After step S27 or step S28, brake ECU 100 returns to step S21 and waits for reception of a braking instruction frame.

### [1.10 Cooperative Operation of ECUs for Emergency Braking Function According to Modification]

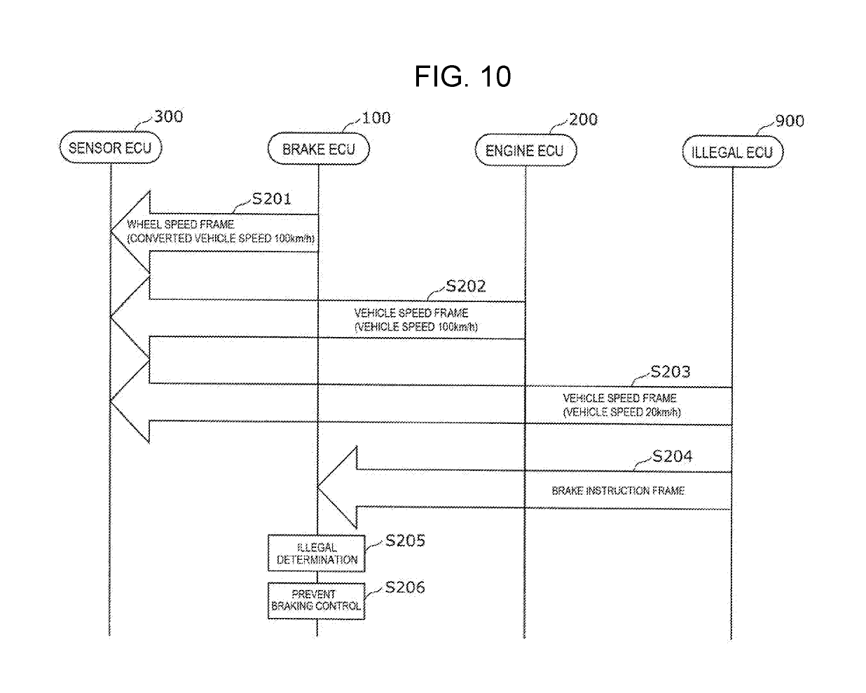

FIG. 10 illustrates an example of a process sequence among a plurality of ECUs that cooperate with each other for the emergency braking function according to the modification of the first exemplary embodiment. In this example, a vehicle speed frame falsified to indicate a low vehicle speed is transmitted, over bus 30, by an attacker from illegal ECU 900, and then a braking instruction frame indicating an instruction to perform braking control is transmitted over bus 30 to illegally activate emergency braking in a situation where emergency braking is not required because vehicle 20 is travelling at a high speed. Herein, brake ECU 100 uses a vehicle speed frame containing vehicle speed data indicating a vehicle speed as a state of vehicle 20 for condition determination whether braking control can be performed on vehicle 20 and does not perform braking control based on the braking instruction frame when vehicle 20 is travelling at high speed (for example, 70 km/h or higher).

In step S201, brake ECU 100 transmits, over bus 30, a wheel speed frame indicating a wheel speed corresponding to a high vehicle speed of 100 km/h converted from a wheel speed acquired from wheel speed sensor 101. Sensor ECU 300 receives the wheel speed frame.

Next, in step S202, engine ECU 200 transmits, over bus 30, a vehicle speed frame containing, in the data field, vehicle speed data indicating a high speed of 100 km/h generated based on the wheel speed acquired from wheel speed sensor 101. This vehicle speed frame is received by, for example, sensor ECU 300, and brake ECU 100.

Next, in step S203, illegal ECU 900 transmits, over bus 30, a vehicle speed frame containing vehicle speed data falsified to indicate a low vehicle speed of 20 km/h. This is an attack that causes brake ECU 100 to erroneously recognize that the vehicle speed of vehicle 20 is low. This vehicle speed frame is also received by, for example, sensor ECU 300, and brake ECU 100.

Next, in step S204, illegal ECU 900 transmits, over bus 30, a braking instruction frame containing control data indicating a deceleration amount that is equivalent to full braking. This is an attack that causes brake ECU 100 to erroneously recognize that vehicle 20 is traveling at a low speed and activate emergency braking.

In step S205, brake ECU 100 that has received the braking instruction frame makes determination on a vehicle speed frame already received and corresponding to a determination target frame (that is, a vehicle speed frame indicating 20 km/h) based on sensor information on a wheel speed. In step S204, a wheel speed indicated by the latest sensor information acquired by brake ECU 100 is equivalent to a vehicle speed of 100 km/h Thus, brake ECU 100 determines in step S205 that the vehicle speed frame is illegal because a value of the vehicle speed data falsified to indicate a vehicle speed of 20 km/h is out of the range of the lower limit value of 95 km/h to the upper limit value of 105 km/h specified in the illegality determination condition (refer to FIG. 6).

In step S206, brake ECU 100 determines that the vehicle speed frame is illegal in step S205, which prevents braking control based on the braking instruction frame received.

### [1.11 Effects of Modification of First Exemplary Embodiment]

In the in-vehicle network system according to the modification of the first exemplary embodiment, brake ECU 100 determines whether content of a vehicle speed frame indicating a vehicle speed is illegal based on sensor information on a wheel speed acquired over the exclusive line from wheel speed sensor 101 when receiving a braking instruction frame indicating an instruction to perform braking control as a specific control on the vehicle. That is, in this modification, determination is made when the second-type frame (in this example, a braking instruction frame) is received rather than when the first-type frame corresponding to a determination target frame (in this example, a vehicle speed frame) is received.

The vehicle speed frame contains vehicle speed data used, in brake ECU 100, for condition determination whether braking control can be performed; thus, determination is made when the braking instruction frame is received, which allows efficient determination. Then, in a case where the determine result indicates that the content is illegal, brake ECU 100 prevents braking control. That is, brake ECU 100 can determine that the vehicle speed frame transmitted by the attacker is illegal, which makes it possible to prevent braking control from being performed based on an illegal braking instruction frame.

### Second Exemplary Embodiment

Hereinafter, a description will be given of in-vehicle network system 10a resulting from partially modifying the configuration of in-vehicle network system 10 according to the first exemplary embodiment (refer to FIG. 1). In the first exemplary embodiment, brake ECU 100 as an example of the information processing device that performs the illegal frame determination process determines whether content of a determination target frame is illegal based on sensor information that is acquired over an exclusive line and indicates a sensing result of a sensor, the determination target frame being assumed to be generated from the sensing result of the same sensor. In contrast, in-vehicle network system 10a according to the present exemplary embodiment, the information processing device that performs the illegal frame determination process determines whether content of a determination target frame is illegal based on sensor information that is acquired over an exclusive line and indicates a sensing result of a sensor, the determination target frame being assumed to be generated from a sensing result of a different sensor having a sensing range overlapped with the sensing range of the sensor.

[2.1 Configuration of in-vehicle network system 10a]

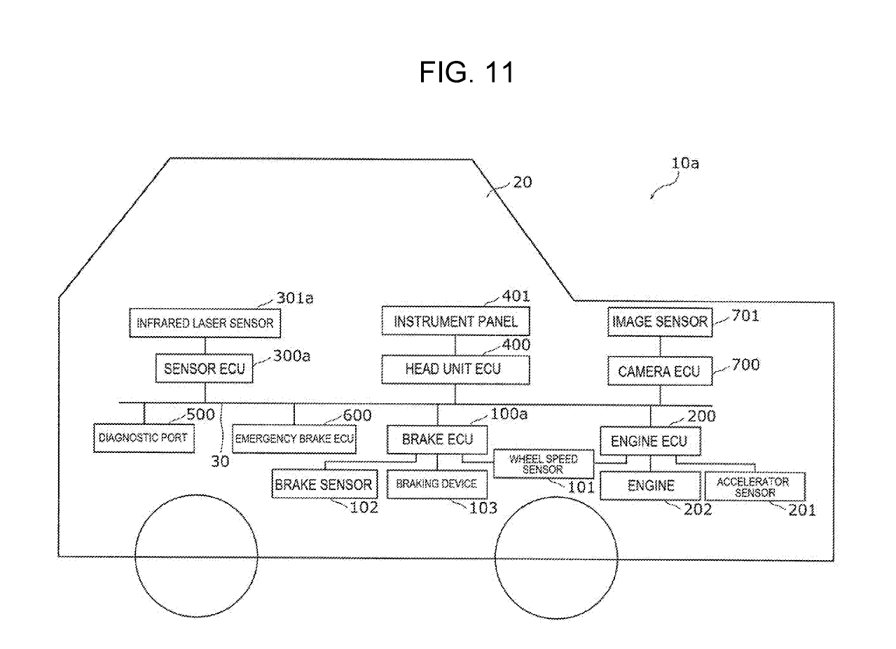

FIG. 11 is a diagram illustrating an overall configuration of in-vehicle network system 10a according to the present exemplary embodiment.

In-vehicle network system 10a includes bus 30, a plurality of ECUs, diagnostic port 500, wheel speed sensor 101, brake sensor 102, braking device 103, accelerator sensor 201, engine 202, infrared laser sensor 301a, instrument panel 401, and image sensor 701. The plurality of ECUs include brake ECU 100a, engine ECU 200, sensor ECU 300a, head unit ECU 400, emergency brake ECU 600, and camera ECU 700. Although not illustrated in FIG. 11, in-vehicle network system 10a may further include a number of ECUs in addition to brake ECU 100a, engine ECU 200, sensor ECU 300a, head unit ECU 400, emergency brake ECU 600, and camera ECU 700 that are all connected to bus 30.

In in-vehicle network system 10a, camera ECU 700 serves as an information processing device that performs an illegal frame determination process. Of the constituent components of in-vehicle network system 10a, constituent components identical to the constituent components of in-vehicle network system 10 according to the first exemplary embodiment (refer to FIG. 1) are denoted, in FIG. 11, by the same reference numerals in FIG. 1, and descriptions of such constituent components are omitted. Furthermore, in-vehicle network system 10a has the same configuration as in-vehicle network system 10 has, unless otherwise described.

Brake ECU 100a is identical to brake ECU 100 according to the first exemplary embodiment except that brake ECU 100a is not capable of serving as an information processing device that performs the illegal frame determination. Note that, in-vehicle network system 10a may include brake ECU 100 instead of brake ECU 100a.

Sensor ECU 300a is connected to infrared laser sensor 301a via an exclusive line. Infrared laser sensor 301a performs sensing on a certain wide area on a road in the travelling direction of vehicle 20 and transmits, to sensor ECU 300a, a sensing result indicating, for example, presence or absence of an obstacle, and coordinates of the obstacle. Herein, a description will be given of an infrared laser sensor as an example of a sensor connected to sensor ECU 300a, but various other types of sensor devices such as a millimeter-wave radar, an ultrasonic sonar, and a LIDAR can also be used.

Sensor ECU 300a is capable of transmitting, over bus 30, a data frame based on a sensing result received from infrared laser sensor 301a. Note that, unlike sensor ECU 300 according to the first exemplary embodiment, sensor ECU 300a is not capable of transmitting the braking instruction frame related to an instruction applied to brake ECU 100a.

Emergency brake ECU 600 that controls execution of the emergency braking function of the ADAS is capable of transmitting the braking instruction frame related to an instruction applied to brake ECU 100a based on a data frame received over bus 30. Herein, a description will be given of the emergency braking function as an example, but vehicle's acceleration, deceleration, and steering intervention control function or the like in various types of driver assistance function including a cruise control function for causing a vehicle to follow a leading vehicle, a lane keeping assistance function, and a parking assistance function can be also achieved. Moreover, an emergency stop function or a control speed changing function for a production facility in a factory can be also achieved.

Emergency brake ECU 600 calculates a deceleration amount for braking control of vehicle 20 using specific algorithm and transmits, over bus 30, a braking instruction frame containing the deceleration amount. For example, in a case where an obstacle that cannot be avoided by steering control and the like is detected in front of vehicle 20 and the vehicle speed of vehicle 20 is not zero, emergency brake ECU 600 determines to activate emergency braking and calculates the deceleration amount such that vehicle 20 is sufficiently decelerated.

Camera ECU 700 is connected to image sensor 701 via an exclusive line. Image sensor 701 performs sensing on an area round vehicle 20 through capturing an image and transmits, to camera ECU 700, a sensing result indicating, for example, presence or absence of an obstacle and coordinates of the obstacle. Note that, image sensor 701 may include a plurality of image sensors mounted at mutually different positions on vehicle 20. Camera ECU 700 is capable of transmitting, over bus 30, a data frame based on a sensing result received from image sensor 701. Camera ECU 700 is further capable of serving as an information processing device that performs the illegal frame determination process. The information processing device implemented in camera ECU 700 makes, as the illegal frame determination process, determination whether a determination target frame of the same type as a data frame transmitted by sensor ECU 300a over bus 30 in the normal state is illegal based on sensor information indicating a sensing result of image sensor 701.

### [2.2 Frame to be Transmitted and Received for Emergency Braking Function]

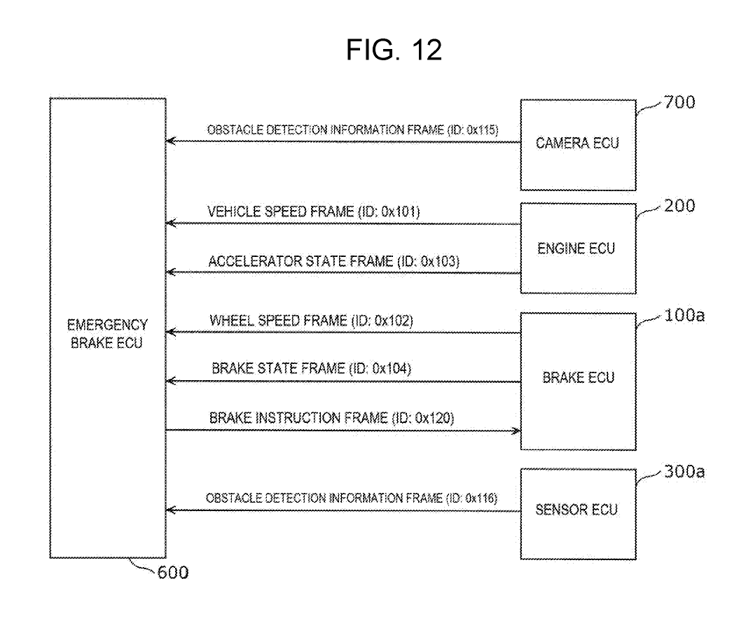

FIG. 12 illustrates examples of frames to be transmitted and received between ECUs for an emergency braking function according to the present exemplary embodiment.

Camera ECU 700 transmits, over bus 30, an obstacle detection information frame corresponding to a data frame that contains, in the data field, data indicating, for example, presence or absence of an obstacle and coordinates of the obstacle based on a sensing result of image sensor 701 and an ID of “0x115”.

Engine ECU 200 successively transmits a vehicle speed frame and an accelerator state frame over bus 30.

Brake ECU 100a transmits a wheel speed frame and a brake state frame over bus 30.

Sensor ECU 300a transmits, over bus 30, an obstacle detection information frame corresponding to a data frame that contains, in the data field, obstacle detection information indicating, for example, presence or absence of an obstacle and coordinates of the obstacle as a sensing result of infrared laser sensor 301a and an ID of “0x116”. Note that, the obstacle detection information frame transmitted by sensor ECU 300a and the obstacle detection information frame transmitted by camera ECU 700 have different IDs, that is, different types. Sensor ECU 300a that transmits the obstacle detection information frame containing the ID of “0x116” successively transmits, in the normal state, the obstacle detection information frame containing obstacle detection information generated based on a result of sensing of infrared laser sensor 301a that performs sensing on all or part of a target range of sensing of image sensor 701.

Emergency brake ECU 600 receives a vehicle speed frame, an accelerator state frame, a wheel speed frame, a brake state frame, and two types of obstacle detection information frames over bus 30. Emergency brake ECU 600 determines whether emergency braking is to be activated based on, for example, a vehicle speed frame received and calculates a deceleration amount for braking control of vehicle 20 using specific algorithm based on the determination result. Then, emergency brake ECU 600 transmits, over bus 30, a braking instruction frame corresponding a data frame containing, in the data field, the deceleration amount thus calculated and the ID of “0x120”.

For example, in a case where an obstacle that cannot be avoided by steering control and the like is detected in front of vehicle 20 and the vehicle speed of vehicle 20 is not zero, emergency brake ECU 600 determines to activate emergency braking and calculates the deceleration amount such that vehicle 20 is sufficiently decelerated. Note that, emergency brake ECU 600 temporarily stores the received frames into a data buffer corresponding to, for example, a region of the memory for efficient processing and can retrieve the frames from the data buffer at a timing synchronized with transmission intervals of the braking instruction frame.

Brake ECU 100a can control braking device 103 and the like in accordance with the deceleration amount in the braking instruction frame.

Note that, although not illustrated in FIG. 12, head unit ECU 400 can receive, for example, the two types of obstacle detection information frames to cause instrument panel 401 to display information based on the content of obstacle detection information frames.

### [2.3 Configuration of Camera ECU 700]

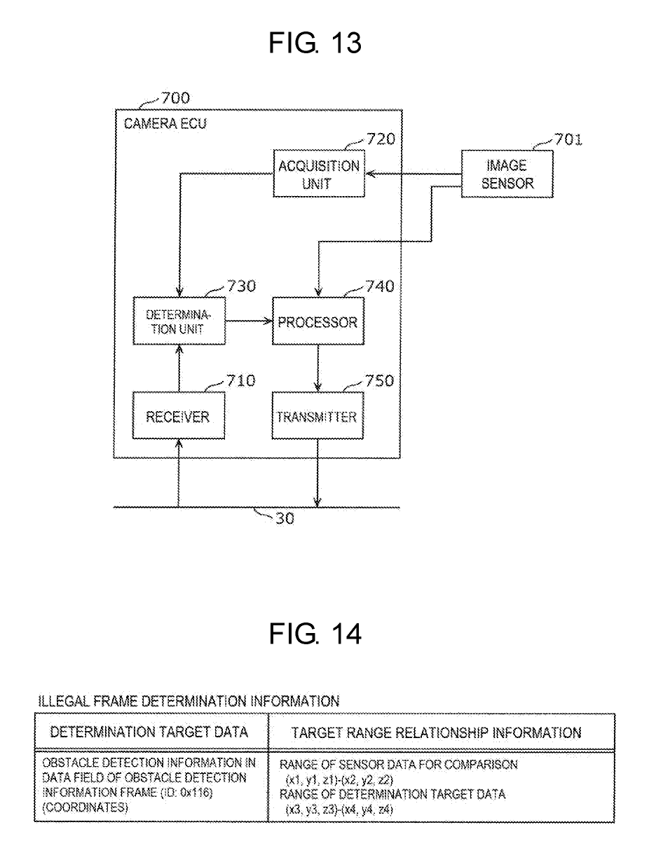

FIG. 13 is a block diagram of camera ECU 700. FIG. 13 includes image sensor 701 directly connected to camera ECU 700 via an exclusive line. Although a plurality of image sensors can be connected, for example, in longitudinal and lateral directions, a configuration with a single image sensor is employed herein for the sake of convenience.

Camera ECU 700 that controls, for example, braking device 103 is capable of serving as an information processing device that performs an illegal frame determination process, such as determination on a determination target frame of a specific type. Herein, a description will be given on the assumption that the determination target frame of the specific type corresponds to the obstacle detection information frame containing the ID of “0x116”.

Camera ECU 700 includes receiver 710, acquisition unit 720, determination unit 730, processor 740, and transmitter 750.

Receiver 710 and transmitter 750 are implemented by, for example, an integrated circuit that controls communication over bus 30, as with receiver 110 and transmitter 150 according to the first exemplary embodiment, and transmit and receive frames in accordance with the CAN protocol. Receiver 710 receives a frame over the in-vehicle network, that is, bus 30 and interprets the frame, and transmitter 750 transmits a frame over bus 30. Receiver 710 determines whether a value determined to be an ID field corresponds to the ID of “0x116” of a determination target frame to be received and terminates the interpretation of the frame when the value is not the ID to be received. Receiver 710 transmits content of the frame thus interpreted to determination unit 730.

Acquisition unit 720 acquires sensor information indicating a result of sensing transmitted from image sensor 701 over the exclusive line. Acquisition unit 720 is implemented in camera ECU 700 by, for example, a communication circuit for communication with image sensor 701 over the exclusive line, and a processor that executes a program, and a memory. Acquisition unit 720 can repeatedly acquire the sensor information, for example, at constant intervals (for example, intervals of several hundred milliseconds).

Determination unit 730 is implemented by, for example, a processor that executes a program. Determination unit 730 determines whether content of a frame received by receiver 710 is illegal based on the latest sensor information acquired by acquisition unit 720, under, for example, a predetermined determination condition.

An example of information for illegal frame determination representing determination conditions used by determination unit 730 is illustrated in FIG. 14. Such information for illegal frame determination corresponds to information in which a determination target data and target range relationship information are associated with each other. The determination target data corresponds to information for identifying a determination target frame that is a determination target of determination unit 730 and data that is the content of the determination target frame. The target range relationship information corresponds to information set based on respective target ranges of sensing of a sensor that outputs a result of sensing that is a base of the determination target data and a sensor that outputs a result of sensing that is abase of sensor data for comparison that is compared with the determination target data for determination related to agreement. The sensor data for comparison corresponds to sensor information acquired by acquisition unit 720. To be more specific, the target range relationship information corresponds to information for identifying, for example, an overlapping range between a sensing range of infrared laser sensor 301a and a sensing range of image sensor 701 to make the determination target data and the sensor data for comparison comparable.

The example of information for illegal frame determination illustrated in FIG. 14 indicates that an obstacle detection information frame containing the ID of “0x116” is to be a determination target frame. Furthermore, the information for illegal frame determination indicates that determination is to be made by comparing obstacle detection information in a predetermined specific position in the obstacle detection information frame with the sensor data for comparison corresponding to sensor information indicating a result of sensing of image sensor 701. Furthermore, the information for illegal frame determination indicates target range relationship information indicating an overlapping portion between a range of the sensor data for comparison and a range of the determination target data, both the ranges being represented by a three-dimensional xyz coordinate system. Note that, in order to make the determination target data and the sensor data for comparison comparable, the target range relationship information may contain information used for conversion between the determination target data and the sensor data for comparison, such as respective units of values of the determination target data and the sensor data for comparison. Furthermore, in a case where respective sensing ranges of the sensors are changed due to, for example, calibration, the target range relationship information may be updated according to the changes.

Determination unit 730 determines, by comparison based on the target range relationship information, whether the obstacle detection information in the data field of the obstacle detection information frame, received by receiver 710, containing the ID of “0x116” is illegal based on the sensor information acquired by acquisition unit 720 from image sensor 701. Then, determination unit 730 determines that the obstacle detection information is illegal in a case where, for example, presence or absence of an obstacle, coordinates of the obstacle, and the like indicated by the obstacle detection information in the obstacle detection information frame, received by receiver 710, containing the ID of “0x116” are in disagreement with (for example, not identical) presence or absence of the obstacle, coordinates of the obstacle, and the like indicated by the sensor information acquired by acquisition unit 720. Otherwise, determination unit 730 determines that the obstacle detection information is not illegal (that is, appropriate). Determination unit 730 notifies processor 740 of the determination result.

Processor 740 executes a predetermined specific process for handling an abnormal state in response to the notification of the determination result from determination unit 730 in a case where determination unit 730 determines that the content of the determination target frame (that is, the obstacle detection information frame containing the ID of “0x116”) is illegal. Furthermore, processor 740 does not execute the specific process in a case where determination unit 730 determines that the content of the determination target frame is not illegal.

The specific process is identical to the specific process in the first exemplary embodiment. For example, processor 740 may be configured to transmit, over bus 30, the error frame via transmitter 750 before receiver 710 receives the last bit of the obstacle detection information frame in a case where determination unit 730 determines that the content of the obstacle detection information frame containing the ID of “0x116” is illegal. Accordingly, before receiver 710 receives the last bit of the obstacle detection information frame, determination unit 730 may determine whether the content of the obstacle detection information frame is illegal and notify processor 740 of the determination result. Transmission of the error frame with the obstacle detection information frame on bus 30 causes the error frame to override the obstacle detection information frame, which in turn causes each ECU connected to bus 30 to discard the obstacle detection information frame.

### [2.4 Illegal Frame Determination Process Performed by Camera ECU 700]

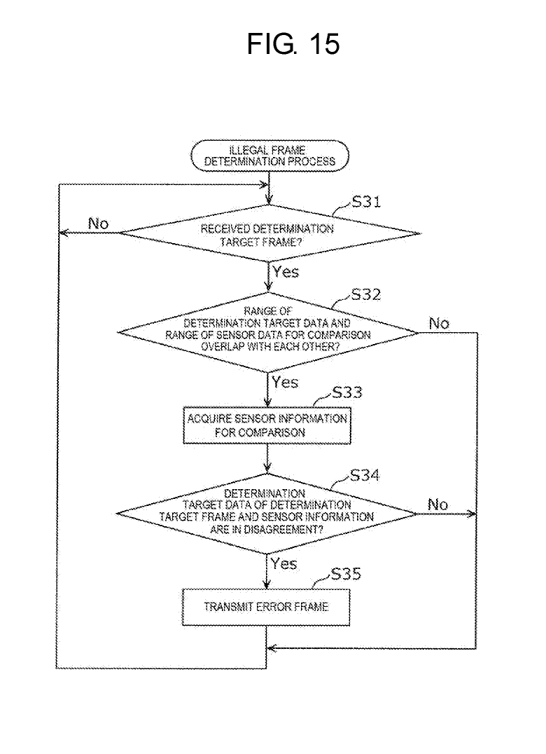

FIG. 15 is a flowchart illustrating an example of an illegal frame determination process performed by camera ECU 700. Hereinafter, a description will be give of the illegal frame determination process with reference to FIG. 15. Herein, the description will be given on the assumption that determination unit 730 of camera ECU 700 makes determination based on the information for illegal frame determination illustrated in FIG. 14. Herein, an example in which camera ECU 700 makes the determination will be given, but sensor ECU 300a can make the same determination.

Camera ECU 700 waits for reception of the obstacle detection information frame corresponding to the determination target frame containing the ID of “0x116” (No in step S31). Then, camera ECU 700 receives the obstacle detection information frame corresponding to the determination target frame containing the ID of “0x116” via receiver 710 (Yes in step S31), and in a case where the range of the determination target data of the determination target frame and the range of the sensor data for comparison overlap with each other (Yes in step S32), the subsequent steps including step S33 are executed. Camera ECU 700 determines, in step S32, the overlap between the range of the determination target data of the determination target frame and the range of the sensor data for comparison based on the target range relationship information of the information for illegal frame determination.

In a case where the range of the determination target data of the determination target frame and the range of the sensor data for comparison overlap with each other (Yes in step S32), camera ECU 700 acquires the sensor information for comparison (that is, the sensor data for comparison) from acquisition unit 720 (step S33).

Next, camera ECU 700 causes determination unit 730 to determine whether the content of the determination target frame is illegal based on whether the determination target data (that is, obstacle detection information) of the determination target frame and the sensor information are in disagreement with each other (step S34). In step S34, determination unit 730 determines whether the determination target data of the determination target frame received via receiver 710 is illegal based on the sensor information, and the target range relationship information (that is, information determined based on the respective target ranges of sensing of infrared laser sensor 301a and sensing of image sensor 701). To be more specific, determination unit 730 makes the determination target data and the sensor data for comparison comparable based on the target range relationship information, and in a case where a difference found in presence or absence of an obstacle, or coordinates of the obstacle is greater than the error, determines that the content (that is, determination target data) of the determination target frame is illegal.

In a case where determination unit 730 determines that there is disagreement in step S34, that is, the content of the determination target frame is illegal (Yes in step S34), camera ECU 700 causes processor 740 to transmit the error frame over bus 30 via transmitter 750 (step S35). Next, returning to step S31, camera ECU 700 waits for reception of a determination target frame.

In a case where determination unit 730 determines that there is no disagreement in step S34, that is, the content of the determination target frame is appropriate (No in step S34), camera ECU 700 skips step S35, returns to step S31, and waits for reception of a determination target frame.

### [2.5 Cooperative Operation of ECUs for Emergency Braking Function]

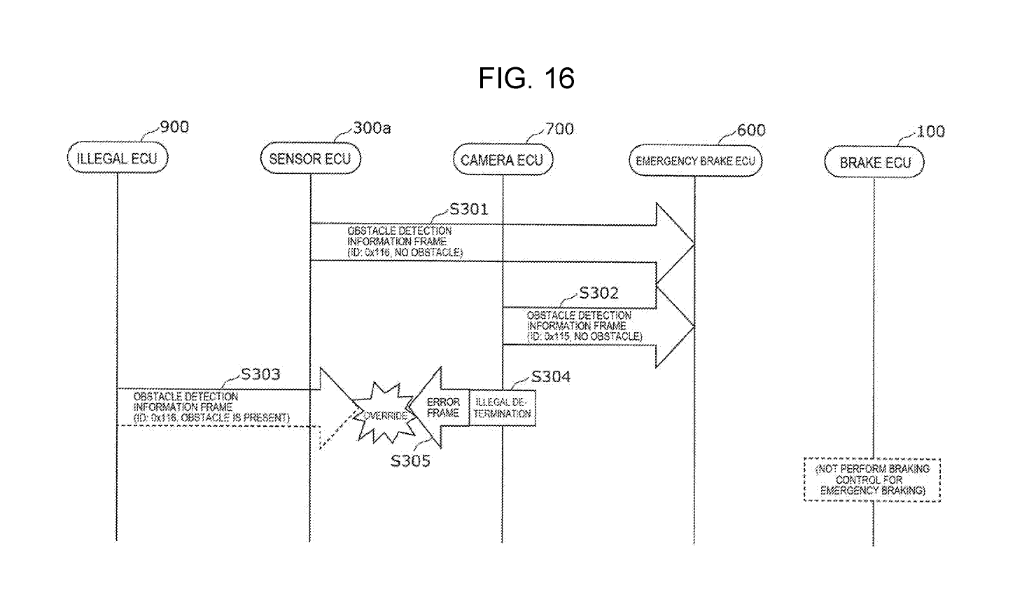

FIG. 16 illustrates an example of a process sequence among a plurality of ECUs that cooperate with each other for the emergency braking function. In this example, an obstacle detection information frame indicating a false obstacle detection information indicating that an obstacle has been detected is transmitted by an attacker from illegal ECU 900 over bus 30 in a situation where no obstacle is present on a road in front of vehicle 20 that is travelling and emergency braking should not be activated.

In step S301, sensor ECU 300a transmits, over bus 30, an obstacle detection information frame that contains, in the data field, obstacle detection information indicating that no obstacle is present on the road in the travelling direction of vehicle 20 and the ID of “0x116” based on a result of sensing of infrared laser sensor 301a. This obstacle detection information frame is received by emergency brake ECU 600. Furthermore, this obstacle detection information frame is also received by camera ECU 700, but camera ECU 700 has already detected that no obstacle is present via image sensor 701; thus, camera ECU 700 does not determine that the obstacle detection information frame is illegal.

Next, in step S302, camera ECU 700 transmits, over bus 30, an obstacle detection information frame that contains, in the data field, obstacle detection information indicating that no obstacle is present on a road in the travelling direction of vehicle 20 and the ID of “0x115” based on a result of sensing of image sensor 701. This obstacle detection information frame is received by emergency brake ECU 600.

Next, in step S303, illegal ECU 900 transmits, over bus 30, an obstacle detection information frame containing obstacle detection information falsified to indicate that an obstacle is present on a road in the travelling direction of vehicle 20. This is an attack that causes emergency brake ECU 600 to activate emergency braking based on the obstacle detection information frame containing the obstacle detection information falsified to indicate that an obstacle is present. This obstacle detection information frame is received by camera ECU 700.

In step S304, since camera ECU 700 has already detected that no obstacle is present via image sensor 701, camera ECU 700 determines that the obstacle detection information frame thus received containing the ID of “0x116” is illegal.

Then, in step S305, camera ECU 700 transmits the error frame. This causes the error frame to overwrite part of the obstacle detection information frame under transmission by illegal ECU 900, which in turn causes the obstacle detection information frame to be overridden, and then discarded in emergency brake ECU 600. Accordingly, emergency brake ECU 600 need not activate emergency braking; thus, emergency brake ECU 600 transmits, over bus 30, a braking instruction frame indicating that the deceleration amount is zero, for example, and then brake ECU 100 that has received this braking instruction frame does not perform braking control for emergency braking.

### [2.6 Effects of Second Exemplary Embodiment]

In in-vehicle network system 10a according to a second exemplary embodiment, camera ECU 700 serves as the information processing device that performs the illegal frame determination process. Then, camera ECU 700 determines whether the content of an obstacle detection information frame containing the ID of “0x116” is illegal based on whether the content and sensor information acquired over the exclusive line from image sensor 701 are in agreement with each other. This is a determination using overlap between respective sensing ranges of two sensors including a first sensor and a second sensor. Sensor ECU 300a transmits, in the normal state, the obstacle detection information frame containing the ID of “0x116” and obstacle detection information based on a result of sensing of infrared laser sensor 301a. Thus, determination on the obstacle detection information frame containing the ID of “0x116” can be made, provided that the sensing range of image sensor 701 that is an example of the first sensor and the sensing range of infrared laser sensor 301a that is an example of the second sensor overlap with each other. This is because respective sensing results of both the sensors have a certain relationship with respect to the overlapping sensing ranges. Then, in a case where the determination result indicates the frame is illegal, camera ECU 700 performs a specific process such as transmission of the error frame.

In a case where an attacker transmits, over bus 30, an illegal obstacle detection information frame that contains the ID of “0x116” and indicates false obstacle detection information, the content of the detection information frame and the sensor information obtained by image sensor 701 are in disagreement with each other, which allows camera ECU 700 to determine that the obstacle detection information frame is illegal and appropriately handle the illegal frame.

### Other Exemplary Embodiments

As described above, the first and second exemplary embodiments have been described as illustrations of the technology in the present disclosure. However, the technology of the present disclosure is not limited to the first and second exemplary embodiments, but is applicable to another exemplary embodiment in which a change, a replacement, an addition, or an omission is appropriately made. For example, the following modifications are also included in one aspect of the present disclosure.

(1) In the exemplary embodiments, the example has been given in which the information processing device is mounted on a vehicle as brake ECU 100 or camera ECU 700, but the information processing device may be mounted in another ECU (for example, head unit ECU 400).

(2) In the exemplary embodiments, the example has been given in which the information processing device is mounted as the ECU (for example, brake ECU 100, camera ECU 700, or the like) that is connected to the in-vehicle network of the in-vehicle network system of the vehicle, but the information processing device is not limited to an in-vehicle device, provided that the information processing device is connected to a network where a plurality of ECUs perform communication. For example, vehicle 20 according to the exemplary embodiments may be replaced with a production facility or a robot in a factory. The information processing device includes a receiver (for example, receivers 110, 710, and the like) that receives a frame over a network, an acquisition unit (for example, acquisition units 120, 720, and the like) that acquires sensor information indicating a result of sensing of a first sensor (for example, wheel speed sensor 101, image sensor 701, and the like), and a determination unit (for example, determination units 130, 730, and the like) that determines whether content of a frame received by the receiver is illegal.

(3) In the first exemplary embodiment, the example has been given in which the information processing device determines whether the content of the vehicle speed frame that can be transmitted by engine ECU 200 that uses a result of sensing of wheel speed sensor 101, based on sensor information indicating the result of the sensing of wheel speed sensor 101. However, a sensor related to the sensor information and a sensor used by an ECU that transmits the determination target frame need not be identical to each other.

The information processing device may be configured to determine whether content of the first-type frame independent of the first sensor is illegal based on the sensor information indicating a result of the sensing of the first sensor. The first-type frame corresponds to a frame of a specific type, that is, the determination target frame. The sensor information indicating the result of the sensing of the first sensor indicates a first-type physical quantity obtained by the sensing of the first sensor, and any ECU that is connected to a network to which the information processing device is connected may transmit, in the normal state, the first-type frame containing data indicating a second-type physical quantity that has a positive or negative correlation with the first-type physical quantity.

For example, the ECU that transmits the first-type frame in the normal state may be configured to transmit the first-type frame based on a different sensor (that is, a sensor other than the first sensor) that performs sensing on the second-type physical quantity that correlates with the first-type physical quantity on which the first sensor performs sensing. In this configuration, the information processing device may determine whether the content of the first-type frame is illegal based on whether the first-type physical quantity indicated by the sensor information and the data contained in the first-type frame have a predetermined correlation.

(4) In the first exemplary embodiment, the example has been given in which brake ECU 100 serving as the information processing device acquires the sensor information from wheel speed sensor 101 over the exclusive line, but the information processing device may be configured to acquire the sensor information indicating the result of the sensing of the first sensor corresponding to, for example, wheel speed sensor 101 over a transmission path other than the exclusive line (for example, bus 30). For example, in a configuration where the ECU serving as the information processing device acquires, over bus 30, sensor information indicating the result of the sensing of the first sensor from the different ECU connected to the first sensor via the exclusive line, the sensor information on bus 30 may be protected by using a cryptographic processing technology such as attachment of a digital signature or encryption.

For example, in a configuration where, in in-vehicle network system 10, head unit ECU 400 instead of brake ECU 100 serves as the information processing device that performs the illegal frame determination process (refer to FIG. 7), head unit ECU 400 may acquire the sensor information from a frame of a specific type that corresponds to a data frame containing the sensor information and is transmitted by brake ECU 100 to acquire the sensor information from the frame of the specific type. The frame of the specific type is a data frame of a certain type containing, for example, a predetermined ID. The frame of the specific type is, for example, a wheel speed frame containing, in the data field, sensor information indicating a result of sensing of a wheel speed sensor. In a case where the content of a determination target frame (for example, a vehicle speed frame) and the sensor information based on frame of the specific type are in disagreement with each other, head unit ECU 400 may presumptively determine that content of the determination target frame is illegal without identifying which of the frames is illegal.

(5) In the exemplary embodiments, the example has been given in which the information processing device makes determination on content of a frame of a specific type, but the information processing device may determine whether content of each of frames of a plurality types is illegal. In this configuration, the information for illegal frame determination (refer to FIG. 6 and FIG. 14) may include, for example, determination target data, an illegality determination condition, and target range relationship information for each determination target frame.

(6) In the exemplary embodiments, as a format of the data frame in accordance with the CAN protocol, the format with standard ID (refer to FIG. 2) is used. Alternatively, the format with extended ID may be used, and an ID contained in the data frame may be, for example, an extended ID in the format with extended ID. Furthermore, the CAN protocol in the exemplary embodiments may include, in a broad sense, derivative protocols such as Time-Triggered CAN (TTCAN), and CAN with Flexible Data Rate (CANFD). Furthermore, a network where ECUs perform communication in a vehicle is not limited to a network in accordance with the CAN protocol, but a different network may be employed. Examples of such a network over which ECUs transmit and receive communication data include Ethernet, Local Interconnect Network (LIN), Media Oriented Systems Transport (MOST) (registered trademark), FlexRay (registered trademark), and BroadR-Reach (registered trademark) protocol.

(7) Each ECU in the exemplary embodiments includes, for example, a digital circuit such as a processor and a memory, an analog circuit, and a communication circuit, but each ECU may further include hardware components such as a hard disk device and a display. Furthermore, the function of each device in the exemplary embodiments may be implemented by dedicated hardware (for example, a digital circuit) rather than by software that causes a processor to execute a program stored in a memory.

(8) The configuration of the respective functional blocks of brake ECU 100 and camera ECU 700 (refer to FIG. 5 and FIG. 13) each serving as the information processing device in the exemplary embodiments is merely an example, and the configuration may be changed as appropriate.

(9) The sequence of steps of each of the various processes in the exemplary embodiments (for example, steps in FIG. 7, FIG. 9, and FIG. 15) is not necessarily limited to the above-described sequence, and modifications may be made without departing from the gist of the present disclosure, such as a change of the execution order of the steps, parallel execution of the steps, or omission of some of the steps.

(10) A part or all of the constituent elements constituting each of the devices in the exemplary embodiments may be constituted of a single-chip system large scale integration (LSI). The system LSI is a super multi-functional LSI manufactured such that a plurality of constituent units is integrated into a single chip, and specifically, is a computer system including a microprocessor, a ROM, a RAM, and the like. A computer program is stored in the RAM. The microprocessor operates in accordance with the computer program, and thus, the system LSI achieves its functions. Furthermore, the constituent components constituting each of the devices may be individually integrated into one chip or may be entirely or partially integrated into one chip. Furthermore, herein, the term of LSI is used. The LSI is also called an integrated circuit (IC), an LSI, a super LSI, and an ultra LSI depending on a degree of integration. The circuit integration technique is not limited to the LSI, but the circuit integration technique may be applied to a dedicated circuit or a general-purpose processor. A field programmable gate array (FPGA) that can be programmed after LSI fabrication or a reconfigurable processor in which connections or settings of circuit cells in the LSI can be reconfigured may be used. When an integrated circuit technology replacing the LSI by the progress of the semiconductor technology or another technology derived from the semiconductor technology emerges, the function block may be integrated using the integrated circuit technology. Possibly, a biotechnology can be applied to the integrated circuit technology.

(11) A part or all of the constituent components constituting each of the devices may be constituted of an IC card or a single module detachable from each of the devices. The IC card or the module is a computer system including a microprocessor, a ROM, a RAM, and the like. The IC card or the module may include the above-described super multi-functional LSI. The microprocessor operates in accordance with the computer program, and thus, the IC card or the module achieves its functions. The IC card or the module may have tamper resistance.

(12) One aspect of the present disclosure may include an information processing method that includes, for example, all or part of the process steps illustrated in FIG. 7, FIG. 9, FIG. 15, and the like. For example, the information processing method is used in an information processing device that is connected to a network where a plurality of ECUs perform communication. The information processing method includes receiving a frame containing data over the network (for example, step S11 related to a receiving process), acquiring sensor information indicating a result of sensing of a first sensor (for example, step S13 related to an acquiring process), and determining whether data (data contained in the frame received in the receiving) is illegal based on the sensor information (for example, step S14 related to a determining process). Furthermore, one aspect of the present disclosure may include a program (computer program) that causes a computer to execute the specific information processes related to the information processing method and digital signals generated by the program.

Furthermore, one aspect of the present disclosure may include a computer readable recording medium that contains the computer program or the digital signals. Examples of the computer readable recording medium include a flexible disk, a hard disk, a CD-ROM, a magneto-optical (MO) disc, a digital versatile disc (DVD), a digital versatile disc read-only memory (DVD-ROM), a digital versatile disc random access memory (DVD-RAM), a Blu-ray disc (registered trademark) (BD), and a semiconductor memory. In addition, the present disclosure may be implemented by using the digital signals stored in those recording media.

One aspect of the present disclosure may include a configuration in which the program or the digital signals are transmitted over a network such as a telecommunications line, a wireless or wired communication line, and the Internet, data broadcasting, and the like. Furthermore, one aspect of the present disclosure may include a computer system including a microprocessor and a memory. The memory may store the computer program, and the microprocessor may operate in accordance with the computer program. The program or the digital signals may be transmitted, with being stored in a recording medium or over a network or the like, to a different computer system that is independently provided and executed by the different computer system.

(13) Another exemplary embodiment implemented by any combination of the constituent components and the functions in the exemplary embodiments and the modifications is also within the scope of the present disclosure.

The present disclosure is applicable in order to enhance security.

What is claimed is:

1. An information processing device connected to a network where a plurality of electronic control units perform communication, the information processing device comprising:
a receiver that receives at least one frame containing data over the network;
an acquisition unit that acquires at least one piece of sensor information obtained by sensing of a first sensor; and
a determination unit that determines whether the data is illegal based on the at least one piece of sensor information.

2. The information processing device according to claim 1, wherein
the at least one piece of sensor information indicates a first-type physical quantity obtained by the sensing of the first sensor,
the plurality of electronic control units include a first electronic control unit,
the at least one frame includes at least one first-type frame that is transmitted by the first electronic control unit,
the at least one first-type frame contains, as the data, data indicating a second-type physical quantity that has a positive or negative correlation with the first-type physical quantity in a normal state, and
the determination unit determines whether the data contained in the at least one first-type frame is illegal based on the at least one piece of sensor information.

3. The information processing device according to claim 2, wherein the determination unit determines that a value is illegal in a case where the value indicated by the data contained in the at least one first-type frame is out of a range from a lower limit value to an upper limit value specified based on the at least one piece of sensor information.

4. The information processing device according to claim 2, wherein the first-type physical quantity and the second-type physical quantity are vehicle speeds.

5. The information processing device according to claim 1, wherein
the plurality of electronic control units include a first electronic control unit,
the at least one frame includes at least one first-type frame that is transmitted by the first electronic control unit,
the at least one first-type frame contains, as the data, data generated based on a result of sensing of a second sensor in a normal state, the second sensor being different from the first sensor and being configured to perform sensing on all or part of a target range of the sensing of the first sensor, and
the determination unit determines whether the data contained in the at least one first-type frame is illegal based on the at least one piece of sensor information.

6. The information processing device according to claim 5, wherein the determination unit determines whether the data contained in the at least one first-type frame is illegal based on the at least one piece of sensor information and information determined based on respective target ranges of the sensing of the first sensor and the sensing of the second sensor.

7. The information processing device according to claim 1, wherein
the plurality of electronic control units includes a first electronic control unit,
the at least one frame includes at least one first-type frame that is transmitted by the first electronic control unit,
the at least one first-type frame contains, as the data, data generated based on a result of the sensing of the first sensor in a normal state, and
the determination unit determines whether the data contained in the at least one first-type frame is illegal based on the at least one piece of sensor information.

8. The information processing device according to claim 2, wherein
the information processing device, the plurality of electronic control units, and the first sensor are mounted on a vehicle,
the network is an in-vehicle network, and
the at least one first-type frame contains, as the data, data indicating a state of the vehicle.

9. The information processing device according to claim 8, wherein
the at least one first-type frame includes a latest first-type frame,
the latest first-type frame contains, as the data, data indicating the state of the vehicle that is used for condition determination whether a specific control on the vehicle is possible, and
the determination unit determines whether the data contained in the latest first-type frame is illegal based on the at least one piece of sensor information when a second-type frame indicating an instruction to perform the specific control is received by the receiver.

10. The information processing device according to claim 2, further comprising a processor that performs a specific process in a case where the determination unit determines that the data contained in the at least one first-type frame is illegal and does not perform the specific process in a case where the determination unit determines that the data contained in the at least one first-type frame is not illegal.

11. The information processing device according to claim 10, wherein the specific process is a process for preventing the at least one first-type frame from being transmitted.

12. The information processing device according to claim 2, wherein
the plurality of electronic control units perform communication over a bus in accordance with a controller area network (CAN) protocol, and
the determination unit determines whether content of the at least one first-type frame is illegal before the receiver receives a last bit of the at least one first-type frame,
the information processing device further comprising a processor that transmits an error frame over the bus before the receiver receives the last bit of the at least one first-type frame in a case where the determination unit determines that the content of the at least one first-type frame is illegal.

13. The information processing device according to claim 2, wherein
the at least one piece of sensor information includes latest sensor information already acquired and sensor information whose term of validity has not expired,
the acquisition unit acquires new sensor information whose term of validity has not expired in a case where the term of validity of the latest sensor information already acquired has expired, and
the determination unit determines whether the data contained in the at least one first-type frame is illegal based on the sensor information whose term of validity has not expired.

14. The information processing device according to claim 2, wherein the determination unit determines whether the data contained in a predetermined specific position in the at least one first-type frame is illegal based on the at least one piece of sensor information.

15. The information processing device according to claim 2, wherein
the plurality of electronic control units include a second electronic control unit that is different from the first electronic control unit,
the at least one frame includes a frame of a specific type that is transmitted by the second electronic control unit,
the frame of the specific type contains, as the data, data generated based on a result of the sensing of the first sensor, and
the acquisition unit acquires the at least one piece of sensor information from the data contained in the frame of the specific type.

16. The information processing device according to claim 1, wherein
the first sensor is connected to the information processing device via an exclusive line that is a wire exclusively used for communication with the information processing device, and
the acquisition unit acquires the at least one piece of sensor information that is transmitted from the first sensor over the exclusive line.

17. The information processing device according to claim 1, wherein the acquisition unit acquires, over the network, the at least one piece of sensor information from an electronic control unit of the plurality of electronic control units, the electronic control unit being connected with the first sensor via an exclusive line that is a wire exclusively used for communication with the first sensor.

18. An information processing method used in an information processing device connected to a network where a plurality of electronic control units perform communication, the information processing method comprising:
receiving a frame containing data over the network;
acquiring sensor information obtained by sensing of a first sensor; and
determining whether the data is illegal based on the sensor information.

19. A non-transitory computer readable recording medium storing a program that causes an information processing device to execute a specific information processing,
the information processing device including a microprocessor and being connected to a network where a plurality of electronic control units perform communication,
the specific information processing including:
receiving a frame containing data over the network;
acquiring sensor information obtained by sensing of a first sensor; and
determining whether the data is illegal based on the sensor information.
